(19) United States
(12) Patent Application Publication
(10) Pub. No.: US 2002/0113824 A1
(43) Pub. Date: Aug. 22, 2002

(54) Graphic user interface that is usable as a commercial digital jukebox interface

(76) Inventor: Thomas D. Myers JR., Ann Arbor, MI (US)

Correspondence Address: Kohn & Associates, Suite 410, 30500 Northwestern Hwy., Farmington Hills, MI, 48334, US

(21) Appl. No.: 09/967,113

(22) Filed: Jan. 14, 2002

Related U.S. Application Data
(60) Provisional application No. 60/240,470, filed on Oct. 12, 2000.

(51) Int. Cl. G09G 5/00

(52) U.S. Cl. 345/810

(57) ABSTRACT

The present invention provides an interactive jukebox including digitally encoded compact discs in a digitally encoded file and a graphic user interface to playing the compact discs, wherein the graphic user interface allows a user to view and manipulate the encoded CDs and select songs from the encoded CDs to be played or supplied. Also provided by the present invention is an interactive graphic user interface for use with a digital jukebox computer system having digitally encoded compact discs in a digitally encoded file format, wherein the graphic user interface allows a user to view and manipulate the encoded CDs and select songs from the encoded compact discs to be played or supplied.

### CROSS-REFERENCE TO RELATED APPLICATIONS

This application claims the benefit of priority under 35 U.S.C. Section 119(e) of U.S. Provisional Patent Application No. 60/240,470, filed Oct. 12, 2000, which is incorporated herein by reference.

### BACKGROUND OF THE INVENTION

1. Field of the Invention

The present invention relates generally to a graphic user interface. More specifically, the present invention relates to a graphic user interface for use with a computer system that has a plurality of digitally encoded audio compact discs (CDs), a touch screen, a sound card, connection to a bill acceptor, and a connection to an external amplifier/speaker system.

2. Description of Related Art

While commercial CD jukeboxes have been available for quite some time, these jukeboxes include only a limited number of CDs, typically 100, a limited interface for browsing these CDs and an extremely limited interface for viewing statistical information, such as the most popular songs. In addition, these jukeboxes are often incapable of offering a search feature and do not make a distinction of the types of music, or genres, contained within them.

The browsing interface of a CD jukebox can be roughly characterized as follows: a clear front holds a series of movable flaps, onto which are affixed one or more renditions of CD cover art, a label denoting the artist for the CD, a unique number for the CD, usually a 2 digit numeric number for a total of 100 unique numbers, and a listing of song titles, or tracks, for the CD, with each track being labeled with a 2 digit number as well. Located near to the enclosure are buttons for manipulating the viewable content of the CDs contained within the enclosure. These buttons are often labeled with a left-arrow and right-arrow, or previous page and next page. In either case, the purpose of one button is to cause the flaps to move such that a user is scrolling back to view CDs labeled sequentially lower than the currently viewable CDs, and the purpose of the other button is to cause the opposite effect such that a user is scrolling forward to view CDs labeled sequentially higher than the currently viewable CDs. Because the means by which CDs are displayed in the enclosure is sequential in nature, a user has to view every CD contained on every flap, or page, from the starting page to the desired page. In the worst case, if a user wants to view a CD that is on the last page in the enclosure, yet the enclosure is currently showing the first page of CDs, then a user has to view the entire contents of the jukebox in order to reach the desired page. It is apparent that this limited interface for browsing CDs has been insufficient for allowing a user to avoid the scenario where all CDs have to be viewed in order to one desired CD is made visible. The insufficient interface poses an increasing problem as the number of CDs that can be stored in a CD jukebox increases. Thus, if a user wishes to play a song from a particular CD, it can be very difficult or time consuming for a user to select that particular CD out of the plurality of CDs in the player, as the plurality of CDs in the player increases.

Additionally, the interface for selecting songs can be roughly characterized as follows: a bill acceptor for inserting money, a one line LED display, buttons for digits 0-9, a button for canceling a selection, a button for entering a selection and a button for flashing a series of selections on the LED display that are the most requested songs. The LED display usually displays the selection being made and the number of selections remaining. A selection is typically a four-digit number. The first two digits represent the number for the CD, usually from 00 to 99, and the second two digits represent the track number of the song as it is located on that CD, usually from 01 to the number of tracks on that CD. For example, 0101, would represent track 01 from the CD numbered 01.

Two factors limit the plurality of CDs in a CD jukebox to one hundred: One is the fact that the typical CD jukebox can only physically accommodate one hundred CDs. The other is the fact that the selection interface for a typical CD jukebox limits a user to 100 distinct choices because of the choice to use only two digits for numbering CDs.

In addition, two factors limit the statistical information that can be conveyed to a user regarding the most requested songs: One is the fact that the browsing interface is static. That is, the paper labels with the song tracks printed out on paper next to them are incapable of being updated in a manner to show which songs are being requested the most, or even which songs are currently selected to be played, but haven't been played yet. Two, is the fact that the only dynamic mechanism available to a user is the one line LED display, that is only capable of displaying a small number of characters. When flashing the most requested songs, only the four digit selection number is given. This one line LED display is not designed to convey information such as artist name, CD title, song name, track number, genre of music or other information over and above the number of the selection.

Furthermore, CD jukeboxes are not capable of providing a search mechanism for a user. If a user wants to find a particular song, they must start at the beginning and browse through every song on every CD throughout the entire plurality of CDs contained in the jukebox. Thus, not only are current CD jukeboxes deficient with respect to search capability, as the plurality of CDs increases, it can be very difficult or time consuming for a user to perform a manual search for a particular song.

Therefore, it would be useful to develop a new jukebox which overcomes all of the above problems. It would also be useful if such jukebox was able to be consistently updated.

### SUMMARY OF THE INVENTION

According to the present invention, there is provided an interactive jukebox including digitally encoded compact discs in a digitally encoded file and a graphic user interface to playing the compact discs, wherein the graphic user interface allows a user to view and manipulate the encoded CDs and select songs from the encoded CDs to be played or supplied. Also provided by the present invention is an interactive graphic user interface for use with a digital jukebox computer system having digitally encoded compact discs in a digitally encoded file format, wherein the graphic user interface allows a user to view and manipulate the encoded CDs and select songs from the encoded compact discs to be played or supplied.

### BRIEF DESCRIPTION OF THE DRAWINGS

Other advantages of the present invention are readily appreciated as the same becomes better understood by reference to the following detailed description when considered in connection with the accompanying drawings wherein:

FIG. 1 is a block diagram representation of the relationship between a graphic user interface constructed in accordance with an embodiment of the invention, and various other interacting features;

FIGS. 2A and B are logical representations depicting the relationship between each of the features of the graphic user interface of the invention.

FIG. 3 is a representation of the display of a CD and related information, for the CDs in a user's digital jukebox computer system, as provided by the graphic user interface of the present invention;

FIG. 4 is a representation of a home screen displayed by the graphic user interface of the present invention;

FIG. 5 is a representation of a search screen displayed by the graphic user interface of the present invention;

FIG. 6 is a representation of a popular screen displayed by the graphic user interface of the present invention;

FIG. 7 is a representation of a genre screen displayed by the graphic user interface of the present invention;

FIG. 8 is a representation of a logon screen displayed by the graphic user interface of the present invention;

FIG. 9 is a representation of an administrative screen displayed by the graphic user interface of the present invention;

FIG. 10 is a representation of a confirmation dialog displayed by the graphic user interface of the present invention;

FIG. 11 is a screen capture representation of a home screen displayed by the graphic user interface of the present invention;

FIG. 12 is a screen capture representation of a search screen displayed by the graphic user interface of the present invention;

FIG. 13 is a screen capture representation of a popular screen displayed by the graphic user interface of the present invention;

FIG. 14 is a screen capture representation of a genre screen displayed by the graphic user interface of the present invention;

FIG. 15 is a screen capture representation of a logon screen displayed by the graphic user interface of the present invention;

FIG. 16 is a screen capture representation of an administrative screen displayed by the graphic user interface of the present invention;

FIG. 17 is a screen capture representation of a confirmation dialog displayed by the graphic user interface of the present invention;

FIG. 18 is a screen capture representation of a disk directory viewer, showing the directories used for the graphic user interface of the present invention on the system drive; and

FIG. 19 is a screen capture representation of a disk directory viewer, showing an example CD layout expected by the graphic user interface of the present invention.

### DETAILED DESCRIPTION OF THE PREFERRED EMBODIMENTS

The present invention provides a graphic user interface for use with a digital jukebox computer system which can render digitally encoded CDs in the file format known as Motion Picture Experts Group Level 1 Audio Level-3 (MP3), or other formats which can be digitally encoded. The present invention also provides a graphic user interface for use with a digital jukebox computer system which allows for the non-sequential browsing of the plurality of digitally encoded CDs.

The graphic user interface of the present invention can be used with a digital jukebox computer system which allows for the identification of digitally encoded CDs, by relative location on the digital jukebox computer system's hard drive, into different categories, or genres, so as to facilitate the non-sequential browsing of the plurality of digitally encoded CDs.

The graphic user interface can also be used with a digital jukebox computer system which allows a user to quickly make a song selection by use of a touch screen that registers a touch over the song title as a request to make that song's unique selection number appear in the interface as the choice a user wishes to make. The graphic user interface displays the cover art for a particular CD next to a listing of the songs that are associated with that particular CD. The graphic user interface can also analyze the age and-play frequency of a particular song and displays this information to a user in the form of usage icons next to the song title in the interface. Additionally, the graphic user interface can analyze the age and play frequency of a set of particular songs that are associated with a digitally encoded CD and displays this information to a user in the form of lists of absolute highest number of plays regardless of age, CDs with the highest ratio of plays per day and a list of the newest CDs in the system.

The graphic user interface can display a list of the most recently played songs that have been played during the duration of the operation of a digital jukebox computer system.

The present invention provides a graphic user interface which allows a user to perform an exhaustive search of the plurality of digitally encoded CDs in the system for a particular text string that is contained in a song's title, author, associated CD title or by any of these fields of information.

The graphic user interface allows for the display of an on-screen keyboard interface that facilitates the entering of textual information by a user to the system. The graphic user interface is also capable of displaying a screen that groups digitally encoded CDs by their relative location on the system's hard drive into different genres of music, which can be selected by a user via a list of those genres that are displayed in a list on-screen.

The present invention provides a graphic user interface which allows a user to touch a button on-screen that shows the information about the currently playing song, as well as information about the other songs associated with the same CD as the currently playing song, in addition to the cover art for said CD. Further, the graphic user interface display information about the currently playing song such as selection number, artist name, song title and genre, information about the number of digitally encoded CDs in the system, information about the number of selection remaining for a user, information about the selection that is currently being made by a user, and information about the range of CD numbers that is currently visible to a user.

The present invention provides a mechanism by which the digital jukebox computer system can exchange meaningful communication with a bill acceptor such that the system can be notified when a user inserts valid U.S. paper currency into the bill acceptor, invalid counterfeit currency into the bill acceptor, or when error conditions occur with the bill acceptor such as whether or not the bill acceptor is jammed or whether or not the bill stacker attached to the bill acceptor is full. Alternatively, the system can accept other forms of payment, for example tokens, credit cards and passcards which maintain a balance of money,

The present invention provides a graphic user interface which allows for the display of a logon screen and selectively grants either administrative-mode access or owner-mode access based upon one of two user ID and password combinations. The graphic user interface allows a user that has entered a correct administrative-mode user ID and password combination at the logon screen to manipulate a song queue, or a list of songs that have been selected to be played, allows that user to store playlists under various names in order to save the contents of the song queue and to allow that user to load playlists under various names in order to displace the contents of the song queue, allows that user to manipulate the volume of the audio signal that is being sent to the external amplifier/speaker system, the ability to browse a table with information on the amount of money that has been accepted by the bill acceptor, and the ability to see a field that shows the play time remaining for the currently playing song.

Additionally, the graphic user interface allows a user that has entered a correct owner-mode user ID and password combination at the logon screen the following capabilities: to selectively delete from the system's hard drive either individual songs or groupings of songs; to selectively add or remove either individual songs or groupings of songs to or from the song queue; to reset the play history of either individual songs or groupings of songs; to expand or collapse the tree view of the contents of the system that is displayed to that user; to bring up a list of duplication song titles that exist in the system; to allow that user to determine a minimum number of songs that are to exist in the song queue; to select songs at random that haven't been played since the last time the usage history has been reset, in the event that the number of songs selected by users is not greater than this minimum number; to specify whether or not to play a randomly selected song at a user-defined time interval, if a song is not already being played; to specify whether or not queued songs should have a special icon representing the queued state to users that are accessing the non-privileged screens of the digital jukebox system's graphic user interface; to manually increment or decrement the number of credits, or number of song selections that can be made by non-privileged users; to allow that user to add new content to the system by initiating a scan of the system's hard disk that searches for encoded CDs that have been copied to the system since the last time this function has been invoked.

More specifically, there is provided a graphic user interface for use with a computer system, and more particularly for use with a digital jukebox computer system that is equipped with a touch-screen, a bill acceptor, a sound card, a connection to an external amplifier/speaker system, and a plurality of digitally encoded CDs, in the MP3 format, is provided. Such computer systems to which the graphic user interface can be applied are described herein by reference. The graphic user interface of the invention can be divided into two panels: a control panel, and a user panel. The control panel is located at the bottom of the screen and is always visible. The user panel is located at the top of the screen and alternates between: a main panel, a search panel, a most popular panel, a genre panel, a logon panel, and an administrative panel.

The graphic user interface interacts with a bill acceptor that allows a user to enter U.S. currency in order to obtain a configurable amount of credits that can be used by a user to select songs that are stored on the digital jukebox computer system that are to be played over the external amplifier/speaker system in the order with which they are requested by a user.

The graphic user interface of the present invention is designed to vaguely resemble the look and feel of mechanical CD jukeboxes in that stored CDs are displayed as distinct units that contain a unique three digit number, the name of the artist, the CD title, CD cover art, a listing of songs, and an arbitrarily assigned genre. Additionally, the graphic user interface is also designed to vaguely resemble the look and feel of mechanical CD jukeboxes in that there is a control panel that contains buttons for scrolling back and forth through the list of stored CDs, and buttons for allowing a user to make numerical selections such that those requested songs are played in the order with which they are requested.

The graphic user interface additionally allows a user to search for particular text either by artist, CD title, song name, or by any of these criteria. The graphic user interface also allows a user to view statistical information for songs, such as the top 50 most played songs, top 100 most played songs, all played songs, or recently played songs. The graphic user interface allows a user to view statistical information for CDs, such as the top 50 most played CDs, the top 100 most played CDs, all played CDs, or the newest CDs that have been added to the system. Furthermore, except for the case of viewing the most recently played songs, either of these views can be sorted using absolute play frequency or by a power ranking that involves calculating a ratio of plays per day of existence in the system. That is, a song or CD that has a lower total number of plays, but a higher play per day ratio, will have a higher power ranking than a different song or CD that has a higher total number of plays, but with a lower play per day ratio. Further, the graphic user interface allows a user the opportunity to view a list of all the genres of music that exist in the system at once, and to automatically skip to the display of the CDs for a particular genre by selecting that particular genre from the list.

When viewing the main user panel, the control panel of the graphic user interface also provides a user scroll buttons for displaying the first “page” of CDs that exist for the first genre of music, the last page of CDs that exist for the last genre of music, the first page of CDs that exist for the previous or next genres of music compared to the genre of music for the currently visible CDs where applicable, and the page that contains the CD for the currently playing song. In addition, there is a “Back” button, which works the same way as a web browser, in that a list of previously viewed pages or screens is stored and can be re-displayed if a user wishes.

The graphic user interface of the present invention accumulates statistical information regarding the age and play frequency of at least one encoded CD, and retains this information in order to facilitate the display of the most popular songs and CDs in the system to a user. Additionally, this information is used in rendering a usage icon next to each song title in a CD panel such that songs satisfying one of 4 levels of play frequency display an icon indicating to a user the level of popularity for a particular song. Also, this information is used to render the color of the border of the CD panel such that CDs whose age is under a configurable threshold has a red border, whereas all other CDs have a white border.

The present invention also provides a password protected screen, or the administrator panel, where either a administrator-level or owner-level user can perform functions pertaining to the configuration of the system, modification of the dynamic song queue, and the addition or removal of encoded CDs. Furthermore, this administrator panel displays a history of important transactions that have occurred such as bill acceptor events or song selections or song plays. Also, this administrator panel displays a table of dollar amounts accepted by the system on a month to month basis.

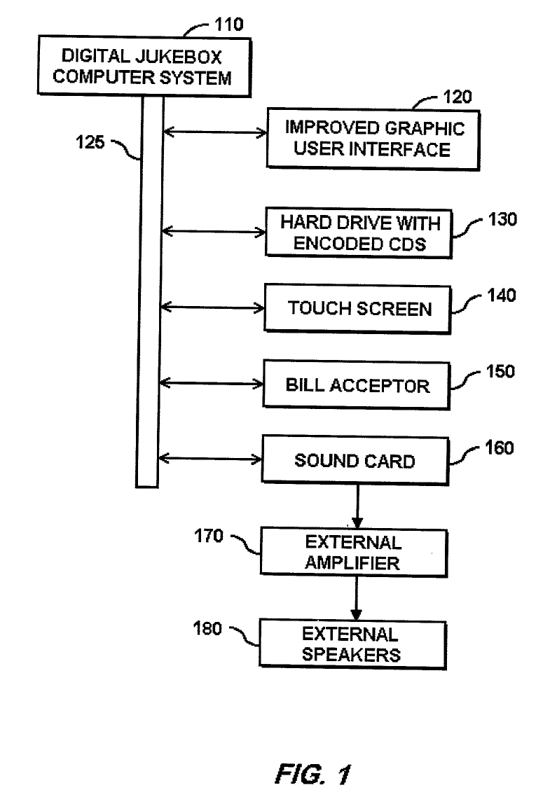

Referring specifically to the figures, FIG. 1 depicts a block diagram of the relationship between a graphic user interface constructed in accordance with the present invention, a digital jukebox computer system, and additional devices. Specifically, a digital jukebox computer system 110 is a personal computer system that runs graphic user interface 120, such as a Java application. The following Examples contain the source code, images, and relevant information needed to construct graphic user interface 120 from scratch. An electrical wiring bus 125, which is internal to digital jukebox computer system 110, is connected to a plurality of devices, such as hard drive with encoded CDs 130, touch screen 140, bill acceptor 150, sound card 160, external amplifier 170, and external speakers 180. Each of the further connected elements shown in FIG. 1 will be described in further depth below.

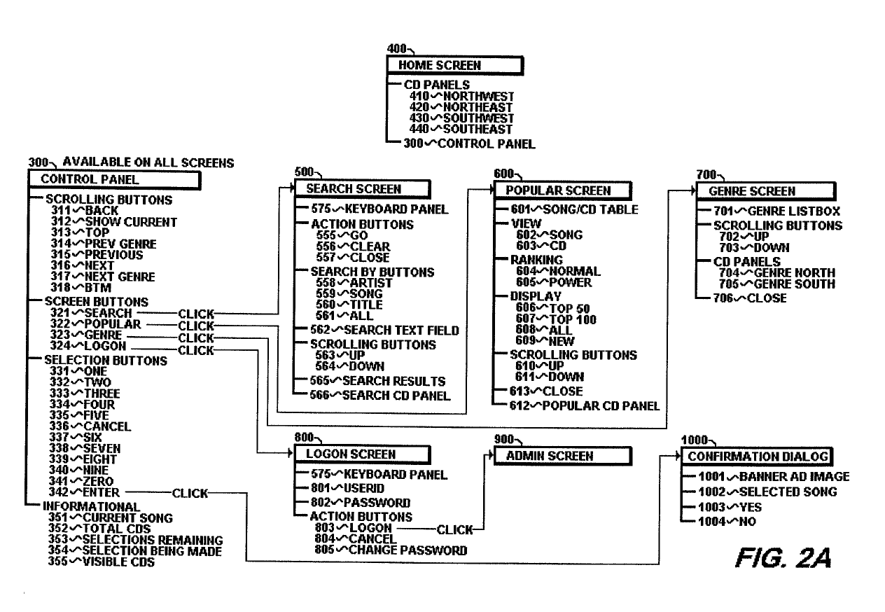

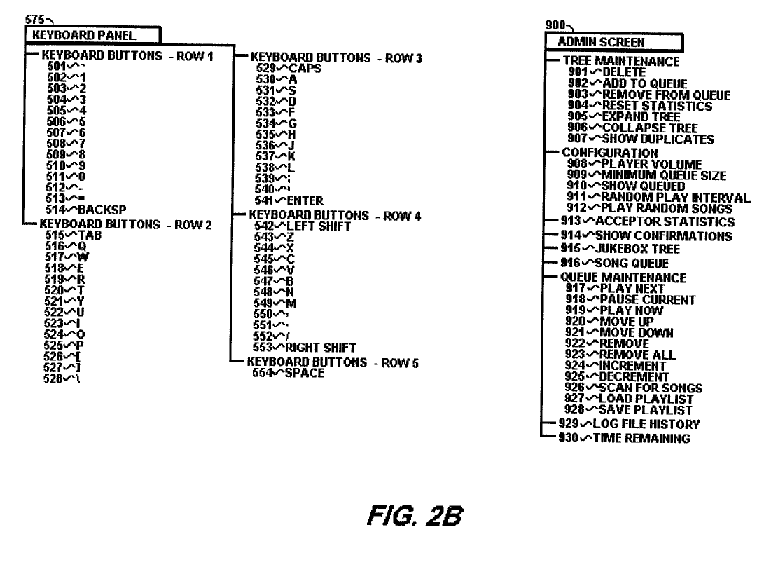

Further, FIG. 2A depicts the logical relationship between the various features and screens of the graphic user interface constructed in accordance with the invention. As is shown in FIG. 2A, one option available on all screens is a control panel 300. The control panel allows a user to navigate the contents of the CD library, determine which screen to display, and enter a selection number in order to request a song to be played. Also included are text fields that display information such as the selection being made, and the number of selections remaining. The number of selections available is initially zero. A user increases the number of selections available by entering any combination of U.S. $1, $2, $5, $10, or $20 dollar bills. The number of selections, or credits, per bill is determined by a configuration file, which is given in the Examples.

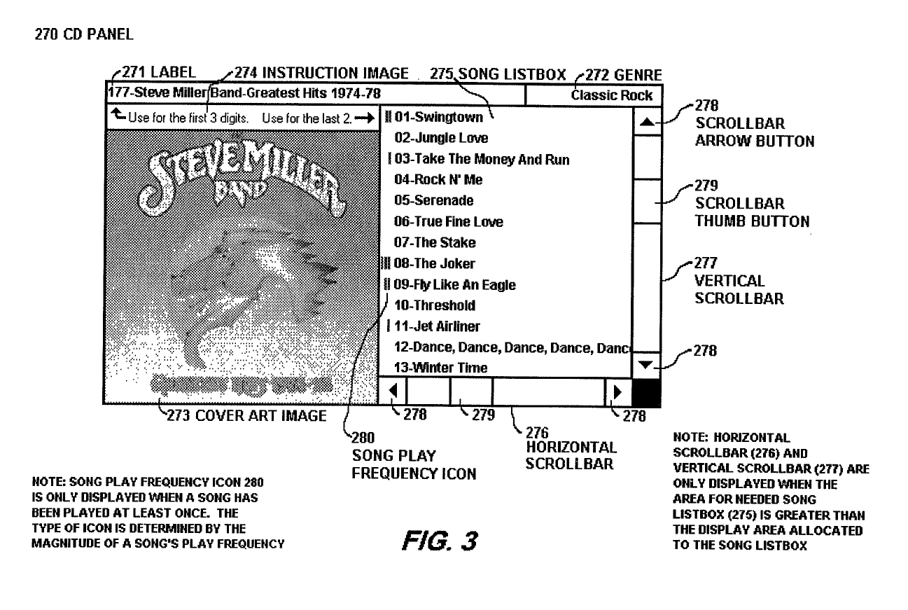

In order to allow a user to make selections, the various screens of the graphic user interface of the invention can display information about a particular CD using a CD panel 270, such that as shown in FIG. 3. The CD panel 270 is comprised of label 271, genre 272, cover art 273, instruction image 274, and song listbox 275. If the text that is contained within song listbox 275 is sufficiently wide enough, then a horizontal scrollbar 276 is displayed. If the horizontal scrollbar 276 is being displayed and there are more than thirteen songs in the listbox, then a vertical scrollbar 277 is displayed. Otherwise, if the horizontal scrollbar 276 is not being displayed, then the vertical scrollbar 277 will be displayed when there are more than fourteen songs in the listbox. Both scrollbars can be used to manipulate the viewable display area of the listbox. If a particular song that is displayed in the listbox has been played a particular number of times, then an appropriate song play frequency icon 280 is displayed next to that song. This icon is used to signify to a user how many times that particular song has been played. For example, an icon with three bars is used to denote that that song has been played more times than a song that has either no icon displayed or an icon with only one or two lines. For a particular CD, a label 271 is made which includes a unique three-digit number, the artist name, and CD title. In the song listbox, between the song frequency icon and the name of the song, there is a unique two-digit number associated with that song, and the number usually matches the track number as found on the physical audio CD. As depicted in instruction image 274, a user uses the three digit number from the label and the 2 digit number associated with a particular song, in order to form a five-digit number that uniquely identifies a particular song throughout the CD library. A user can use a credit to select a particular song to play by either entering this number into the control panel directly, by selecting the song with and then processing the selection in the control panel, or by double-clicking on the song in order to automatically have that selection number entered by the system.

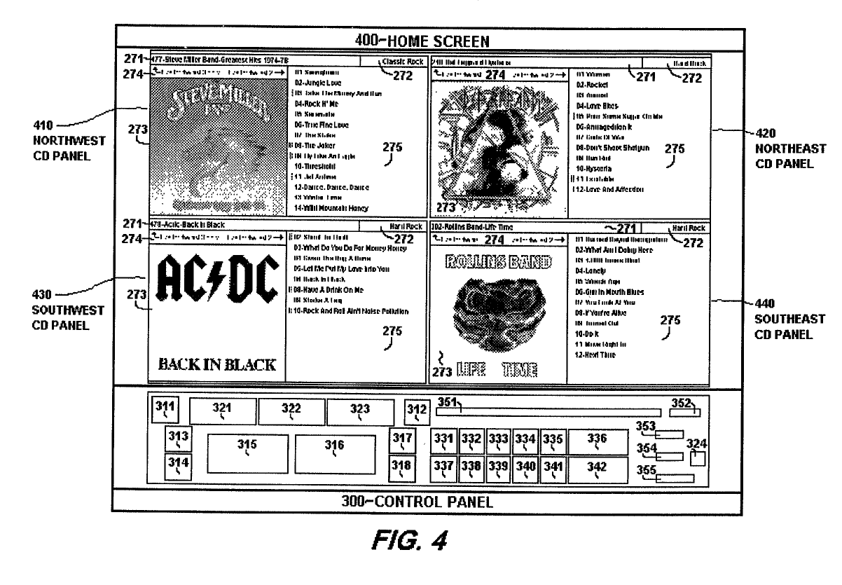

A home screen 400 is first encountered, such that as shown in FIG. 4. The home screen 400 is comprised of northwest CD panel 410 in the upper left hand corner, a northeast CD panel in the upper right hand corner, a southwest CD panel 430 in the lower right hand corner, a southeast CD panel 440 in the lower left hand corner, and control panel 300 at the bottom.

The control panel allows a user to navigate the contents of the CD library by the following scroll/navigation button elements: back 311, show current 312, top 313, previous genre 314, previous 315, next 316, next genre 317, and bottom 318.

“Back” 311 allows a user to backtrack their actions and causes the last screen or screen state to be displayed again on the screen. If there are no previous screens or screen states to be displayed, then the back button can be disabled.

“Show current” 312 allows a user to view the CD that contains the currently playing song to be displayed in the northwest CD panel 410. If there is not a song that is currently playing, or if the home screen is not currently being displayed, then the “show current” button can be disabled.

“Top” 313 allows a user to view the first CD in the CD library in the northwest CD panel. If the first CD in the CD library is already being displayed in the northwest CD panel, then the top button can be disabled.

“Previous genre” 314 allows a user to view the first CD in the CD library where the genre of music associated with that CD is in the previous genre, with respect to the list of genres for the system, as determined by the content of the CD library. If the first CD of the first genre of the list of genres for the system is currently being displayed in the northwest CD panel, then the previous genre button can be disabled.

“Previous” 315 allows a user to view the CDs immediately preceding the currently visible CDs in the CD library. If the CD panel that is currently being displayed in the northwest CD panel is labeled “004” or higher, then the four previous CDs in the CD library will be displayed. Otherwise, the display is the same as that of the top 313 button, in that the first four CDs in the system are displayed, with the first CD in the CD library being displayed in the northwest CD panel. If the first CD in the CD library is already being displayed in the northwest CD panel, then the previous button can be disabled.

“Next” 316 allows a user to view the CDs immediately following the currently visible CDs in the CD library. If the CD panel that is currently being displayed in the northwest CD panel is labeled to be numerically four less than the last CD in the CD library, or greater, then the four next CDs in the CD library are displayed. Otherwise, the remaining CDs in the CD library are displayed, with the last CD being visible on the screen. If the last CD is already visible on the screen, then the next can be disabled.

“Next genre” 317 allows a user to view the first CD in the CD library where the genre of music associated with that CD is in the next genre, with respect to the list of genres for the system, as determined by the content of the CD library. If the first CD of the last genre from the list of genres for the system is currently being displayed on screen, then the next genre button can be disabled.

“Bottom” 318 allows a user to view the last CD in the CD library. If the last CD in the CD library is already being displayed on screen, then the bottom button can be disabled.

As is further shown in FIG. 2A, the control panel allows a user to determine which screen to display by the following screen button elements: search 321, popular 322, genre 323, and logon 324.

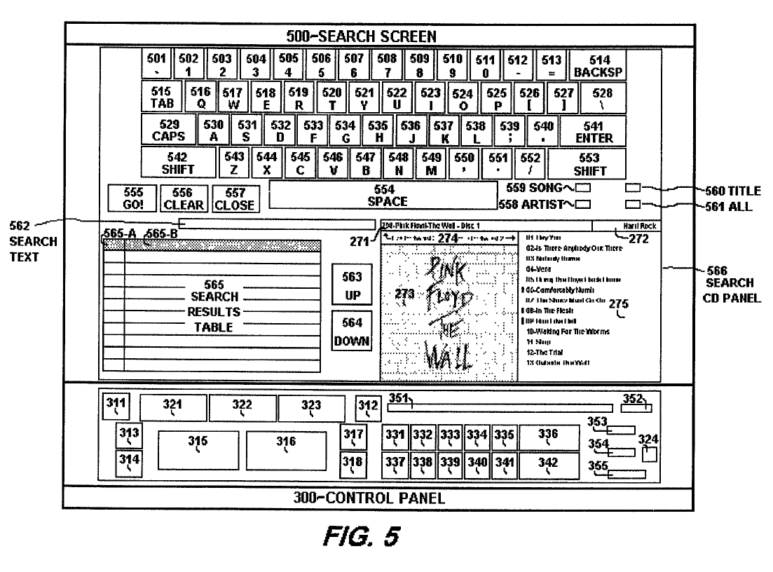

“Search” 321 allows a user to view search screen 500, such that as shown in FIG. 5. When viewing the search screen, the search button 321 is disabled.

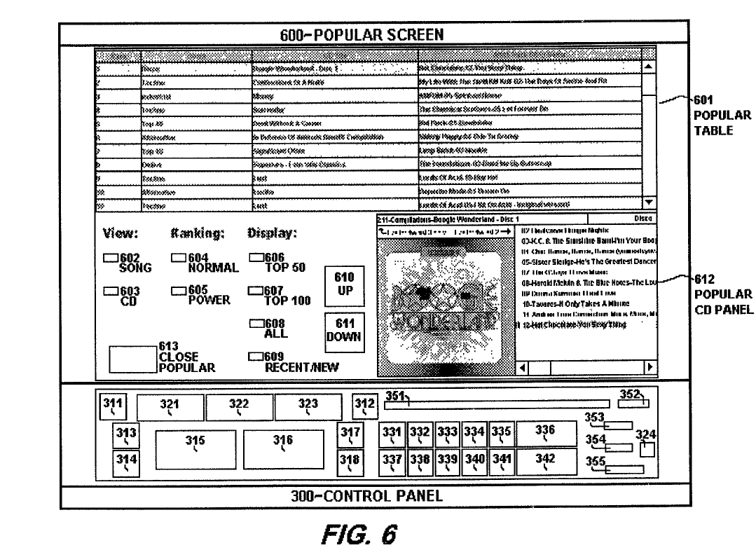

“Popular” 322 allows a user to view popular screen 600, such that as shown in FIG. 6. When viewing the popular screen, the popular button 322 is disabled.

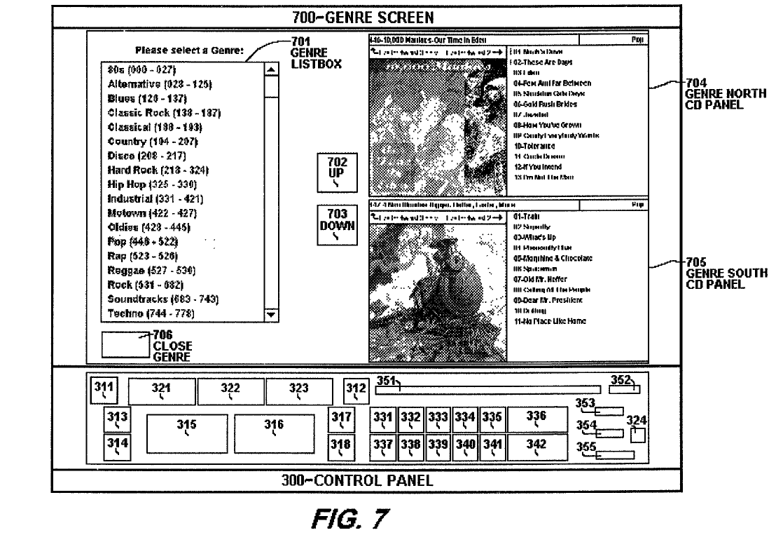

“Genre” 323 allows a user to view genre screen 700, such that as shown in FIG. 7. When viewing the genre screen, the genre button 323 is disabled.

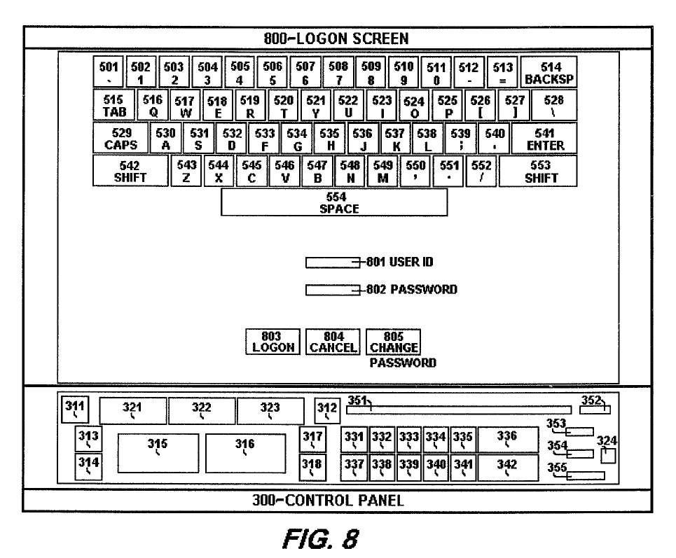

“Logon” 324 allows a user to view logon screen 800, such that as shown in FIG. 8. When viewing the logon screen, the logon button 324 is disabled. Since the logon screen 800 is only intended for a privileged audience, the logon button 324 is rendered invisible on the control panel. Its location is in the lower right-hand corner of the screen and its outline is shown in FIGS. 4-10.

In addition, when viewing either search screen 321, popular screen 322, or genre screen 323, the scroll/navigation button elements, back 311, show current 312, top 313, previous genre 314, previous 315, next 316, next genre 317, and bottom 318, are disabled. That is, the scroll/navigation buttons in the control panel are only used with home screen 400. Search screen 500, popular screen 600, genre screen 700, and logon screen 800 are described in further depth below.

As is further shown in FIG. 2A, the control panel also contains the following labeled text field elements: current song 351, total CDs 352, selections remaining 353, selection being made 354, and visible CDs 355.

The graphic user interface starts with a default of zero credits. This number is displayed in selections remaining 353 text field. When the number of credits increases or decreases, it is reflected in selections remaining 353 text field. A user can increase the number of credits by entering U.S. currency into bill acceptor 150. A user can decrease the number of credits by entering selections, or in other words, five-digit numbers that uniquely identify a particular song from the CD library.

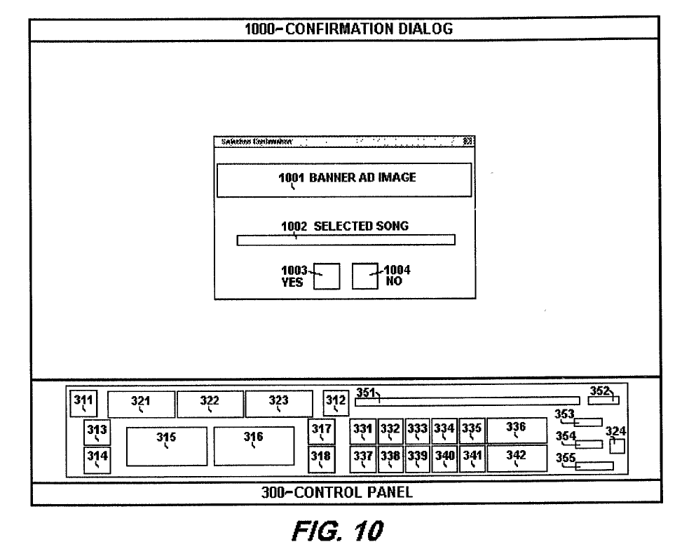

The control panel allows a user to enter a selection by the following selection button elements: one 331, two 332, three 333, four 334, five 335, cancel 336, six 337, seven 338, eight 339, nine 340, zero 341, and enter 342. When one 331 is pressed, the character “1” is added to selection being made 354. When two 332 is pressed, the character “2” is added to selection being made 354. When three 333 is pressed, the character “3” is added to selection being made 354. When four 334 is pressed, the character “4” is added to selection being made 354. When five 335 is pressed, the character “5” is added to selection being made 354. When six 337 is pressed, the character “6” is added to selection being made 354. When seven 338 is pressed, the character “7” is added to selection being made 354. When eight 339 is pressed, the character “8” is added to selection being made 354. When nine 340 is pressed, the character “9” is added to selection being made 354. When zero 341 is pressed, the character “0” is added to selection being made 354. When the number of characters in the selection being made text field is equal to five, then the numbered buttons 331, 332, 333, 334, 335, 337, 338, 339, 340, and 341 are disabled and enter 342 is enabled. When enter 342 is pressed, confirmation dialog 1000, such that as shown in FIG. 10, can be displayed on screen. If a user answers in the affirmative, and a song exists in the CD library that corresponds to the five-digit number entered in selection being made 354, then that particular song is added to a song queue. If no other songs exist in the song queue and no song is currently playing, then that particular song is played immediately. When this happens, then current song 351 is updated to contain text in the form of: “XXXXX—Artist-Song Name (YYY)”, where XXXXX is the five-digit number that identifies the song and YYY is the genre of music associated with that song. In addition, after successfully entering a selection, a user can notice that selections remaining 353 is decreased by one. When the number of characters in the selection being made text field is blank, then the cancel button 336 is disabled. Otherwise, it is enabled, and when pressed, causes the selection being made 354 to be cleared and the numbered buttons to be re-enabled.

In addition, total CDs 352 displays the number of CDs in the CD library. Since the CD labeling starts with “000”, the last CD in the CD library is one less than this number. Visible CDs 355 displays the range of CD labels that are currently visible on the screen. For example, if home screen 400 is being displayed and the CD in the northwest CD panel is labeled “000” and the CD in southeast CD panel is labeled “003”, then visible CDs 355 displays: “000-003”.

As stated before, home screen 400 is the first screen encountered. While this screen is displayed, the area above the always-displayed control panel contains four CD panels. At this screen, a user is allowed to use the scroll/navigation buttons to jump to any arbitrary location in the CD library so that the appropriate CD panels are displayed. A user is also allowed to enter selections. In addition, a user can view: search screen 500 by clicking on search 321, popular screen 600 by clicking on popular 322, genre screen 700 by clicking on genre 323, and logon screen 800 by clicking on logon 324.

FIG. 5 depicts the display of search screen 500. Search screen 500 contains a keyboard panel 575 in the top center. Action buttons, go 555, clear 556, and close 557, are all located next to keyboard panel 575 on the left. “Search by” buttons including artist 558, song 559, title 560, and all 561 are all located next to keyboard panel 575 on the right. Search text field 562 is located below the action buttons. Search scroll buttons, up 563 and down 564, are located below the search text field in the center of the screen. Search results table 565 is located below the search text field to the left of the search scroll buttons. Search CD panel 566 is located to the right of the search scroll buttons.

The keyboard panel 575 implements a “soft” keyboard in that there exists a number of buttons with labels resembling a physical keyboard and whose relative locations match those of a physical keyboard as well. The enumeration of these buttons, as shown in FIG. 2B, and the relative locations of these buttons, as shown in FIG. 5, should suffice to describe them adequately. Therefore, when a button from keyboard panel 575 is clicked, the label of that button is added to search text field 562. For example, if search text field 562 contains the text “depech”, and a user clicks on keyboard panel button e 518, then the character “e” will be added to search text field 562. Thus, the text field will then contain the text “depeche”.

Before describing search functionality, it is necessary to state that each song entry in the CD library has the following information associated with it: genre, artist, CD title, and song name.

When action button go 555 is clicked, the text in search text field 562 is used to submit a query to the graphic user interface of the invention. If the “search by” button artist 558 is toggled, or rendered in a mutually exclusive way from the other search by buttons, then the query only searches in the CD library for the given text that appears in the artist portion of a song entry. Conversely, if “search by” song 559 is toggled, then only the song name portion of a song entry is searched by the query. If “search by” title 560 is toggled, then only the CD title portion of a song entry is searched by the query. If “search by” all 561 is toggled, then all portions of a song entry are searched by the query. The results of the query, or search, is tabulated and displayed in search results table 565. Each entry in search results table 565 contains information associated with a song entry that had the search text in the proper portion of its entry. There are two columns for each entry in search results table 565. CD number 565-A is located in the first column. The unique three-digit number of the CD that contains a particular song is displayed in CD number 565-A. Song information 565-B is located in the second column. The artist portion of the song entry is given, and is followed by the track number and song name. If the query results in zero songs matching the criteria specified by the text in search text field 562 and the toggled “search by” button, then search results table is empty, and search scroll buttons up 563 and down 564 are disabled and the space occupied by search CD panel 566 is left blank. Otherwise, the results are displayed in search results table 565, with the first entry being highlighted and the CD panel associated with that entry being displayed as search CD panel 566. If more than ten song entries are returned, then a vertical scroll bar is displayed to allow the user to traverse the table. Search scroll button up 563 is disabled when the first song entry is highlighted or the table is empty. Search scroll button down 564 is disabled when the last song entry is highlighted or the table is empty. If there is only one song entry, then both will be disabled. A user is allowed to click on down 564 to cause the entry in the table after the currently highlighted entry to be highlighted. In addition, a user is allowed to click on up 563 to cause the entry before the currently highlighted entry to be highlighted. The table only allows for one entry to be highlighted at a time. When a different entry is highlighted, either through the use of the search scroll buttons, or by clicking on the entry directly, the appropriate CD panel is displayed in search CD panel 566. Also, the corresponding song in song listbox 275 of the CD panel is highlighted. As for any CD panel in the graphic user interface of the invention, if there are more than zero credits available to a user, then the effect of highlighting a song in a CD panel is to cause the unique five-digit number associated with that particular song to be automatically displayed in selection text field 354.

In addition to allowing searches for text, the search screen 500 also allows a user to clear the contents of search text field 562, search results table 565, and search CD panel 566, by clicking on clear 556. A user can also click on close 557, after which home screen 400 is re-displayed, search 321 on the control panel is re-enabled, and the scroll/navigation buttons of the control panel are re-enabled.

FIG. 6 depicts the display of the popular screen 600. The popular screen 600 includes a song/CD table 601 at the top, view buttons, song 602 and CD 603, at the left below popular table 601, ranking buttons normal 604 and power 605 to the right of the view buttons, display buttons, top 50 606, top 100 607, all 608, and new/recent 609, to the right of the ranking buttons, popular scroll buttons up 610 and down 611 to the right of the display buttons, popular CD panel 612 to the right of the popular scroll buttons, and the button close popular 613 below the view buttons.

It is necessary to define what is meant by “view”, “ranking”, and “display” in order to describe buttons 602 to 609. “View” has two states: song or CD. When in “song view” mode, only individual song entries are listed in table 601. When in “CD view” mode, only collective CD entries in are listed in table 601. “Ranking” has two states: normal or power. When in “normal ranking” mode, entries contained in the table 601 are ordered such that entries at the top have an absolute higher play frequency than entries below them. When in “power ranking” mode, entries contained in table 601 are ordered such that entries at the top have a higher play-per-day ratio than entries below them. Display has four states: top 50, top 100, all, or new/recent. When in “top 50” mode, there is a maximum of fifty entries contained in the table 601. When in “top 100” mode, there is a maximum of one hundred entries contained in table the 601. When in “all” mode, all songs/CDs that have been requested at least once are displayed in the table 601. When in “all/recent” mode, the most recently played songs are listed in the table 601, when in song view mode otherwise, in CD view mode, the newest CDs that have been added to the CD library are listed in table 601. Therefore, when button song 602 is clicked on, the table display is changed to song view mode. When button CD 603 is clicked on, the table display is changed to CD view mode. When button normal 604 is clicked on, the table display is changed to normal ranking mode. When button power 605 is set, the table display is changed to power ranking mode. When button top 50 606 is clicked on, the table display is changed to top 50 mode. When button top 100 607 is clicked on, the table display is changed to top 100 mode. When button all 608 is clicked on, the table display is changed to all mode. When button new/recent 609 is clicked on and the table display is in song view mode, then button new/recent 609 is labeled “recent”, button power 605 is disabled, and the entries in table 601 are ordered such that the most recently played songs are listed at the top. Otherwise, when button new/recent 609 is clicked on and the table display is in CD view mode, then button new/recent 609 is labeled “new”, and the entries in table 601 are ordered such that the most recently added CDs to the CD library are listed at the top. The threshold for determining if a particular CD is “new” or not, is determined by newCDAgeThreshold XXXX as shown in the following Examples.

In summary of these display modes, the content of the table 601 is determined by fifteen allowable combinations of the view, ranking, and display states. The display state is transitioned when a user clicks on one of the buttons that correspond to these display states. Thus, these fifteen combinations are: 1. Top 50 songs, with normal ranking; 2. Top 100 songs, with normal ranking; 3. All songs, with normal ranking; 4. Most recently played songs; 5. Top 50 songs, with power ranking; 6. Top 100 songs, with power ranking; 7. All songs, with power ranking; 8. Top 50 CDs, with normal ranking; 9. Top 100 CDs, with normal ranking; 10. All CDs, with normal ranking; 11. Newest CDs, with normal ranking; 12. Top 50 CDs, with power ranking; 13. Top 100 CDs, with power ranking; 14. All CDs, with power ranking; and 15. Newest CDs, with power ranking.

Popular scroll buttons, up 610 and down 611, work in a fashion similar to that of search scroll buttons up 563 and down 564. Unless the table 601 is displaying the most recently played songs and a song hasn't been played yet, it has a single entry highlighted. The CD panel associated with this highlighted entry is displayed as popular CD panel 612. If the highlighted entry is at the top of the table, then up 610 is disabled. If the highlighted entry is at the bottom of the table, then down 611 is disabled. Otherwise, when up 610 is clicked on, the next entry in the table is highlighted and the associated CD panel for that particular song/CD is displayed as popular panel 612. In addition, if in song view mode, the entry for that particular song is highlighted in the CD panel.

Furthermore, for the popular screen 600, when a user clicks on button popular close 613, home screen 400 is re-displayed, popular 322 on the control panel is re-enabled, and the scroll/navigation buttons of the control panel are re-enabled.

FIG. 7 depicts the display of genre screen 700. Genre screen 700 is comprised of genre listbox 701 at the left, genre scroll buttons up 702 and down 703 to the right of genre listbox 701, genre north CD panel 704 in the upper right-hand corner, genre south CD panel 705 in the lower left-hand corner, and button genre close 706 below genre listbox 701.

Genre listbox 701 contains a list of genres for the CDs that exist in the CD library. This list is determined by how the CDs are arranged on hard drive 130, as shown in the following Examples. If the number of genres is greater than what can be displayed in listbox 701, then a vertical scrollbar 277 is displayed. When a user first encounters the genre screen 700, the genre corresponding to the genre that is shown in northwest CD panel 410 of home screen 400, is highlighted. Furthermore, genre north CD panel 704 displays the same CD panel as shown in northwest CD panel 410 of home screen 400. If there is another CD in the CD library that follows the CD shown in genre north CD panel 704 and is in the same genre, then the corresponding CD panel is displayed as genre south CD panel 705. Otherwise, the CD panel corresponding to the first CD in that genre is displayed. If there is only one CD for that genre, then genre south CD panel 705 is not displayed.

The table 701 allows only one genre to be highlighted at any point in time. A user is allowed to change this highlighted entry in two ways. The first is by returning to home screen 400, scrolling through the appropriate CD panels, then returning to genre screen 700. The second way a user is allowed to change this highlighted entry is by clicking on a different genre directly in listbox 701.

Clicking on genre scroll button up 702 allows a user to view the previous two CD panels for the given genre, relative to the CD panels already being displayed. If there aren't any more previous CD panels to be displayed, then the last two CD panels for that genre are displayed. Clicking on genre scroll button down 703 allows a user to view the next two CD panels for the given genre, relative to the CD panels already being displayed. If there is only one more CD panel for the given genre to be displayed, then it is shown in genre north CD panel 704 and genre south CD panel 705 is not displayed. If there aren't anymore further CD panels to be displayed, then the first two CD panels for that genre are displayed.

Furthermore, for genre screen 700, when a user clicks on button genre close 706, home screen 400 is re-displayed, genre 323 on the control panel is re-enabled, and the scroll/navigation buttons of the control panel are re-enabled.

FIG. 8 depicts the display of logon screen 800. Logon screen 800 is comprised of a keyboard panel 575 in the top center. Text field user ID 801 is displayed below keyboard panel 575. Text field password 802 is displayed below user ID 801. Buttons logon 803, cancel 804, and change password 805 are located one after another in a row below password 802.

The behavior of the keyboard panel 575 is the same as it is in the search screen 500, except that the character “pressed” by a user is put into user ID 801. When the length of this text reaches six characters, any further characters are put into password 802 in masked form, that is, the identity of the actual characters are hidden, and the pound sign character, “#”, is displayed instead. When the length of the password field reaches eight characters, both logon 803 and change password 805 buttons are enabled.

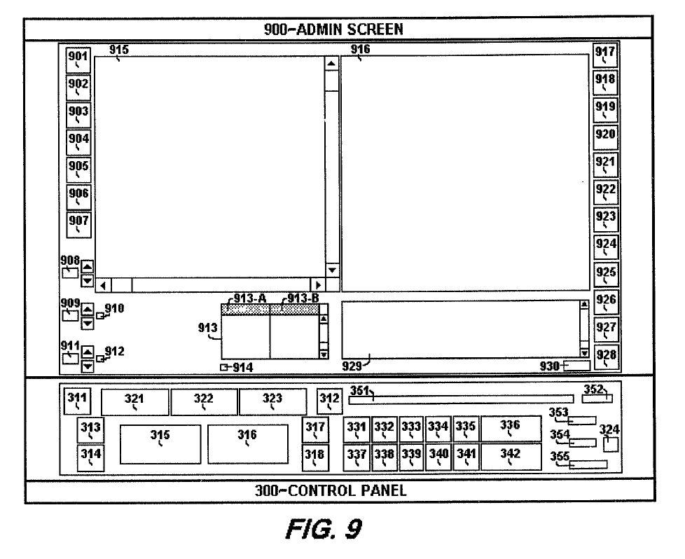

When the graphic user interface 120 is first run, there are two default user ID and password combinations. The first is “ADMIN” and “PASSWORD”, respectively. The second is “OWNER” and “PASSWORD”, respectively. If a, presumably, privileged user knows how to enter the logon screen in the first place and knows either user ID and password combination, then that user can proceed by clicking on logon 803. The password “PASSWORD” itself, is not allowable, otherwise the purpose of this screen would be comprised. When this password is encountered, the user is prompted to change it to something that presumably, only he or she would know. After this occurs, admin screen 900 is displayed, similar to that shown in FIG. 9. A user that enters the correct password for either “ADMIN” or “OWNER” is said to be a privileged user. If that user enters the correct password for “OWNER” the user is said to have owner-level access. Otherwise, a user who knows neither is said to be non-privileged.

A privileged user is allowed to change the password for the user ID and password combination that they have knowledge of, by clicking on change password 805 once the correct user ID and password have been entered.

In the event that any type of user accidentally clicks on the invisible logon 324, which is the area beside selection being made 354 on the control panel, then that user can exit logon screen 800 by clicking on cancel 804. If the logon screen is displayed for more than two minutes, then any action is canceled and the screen is automatically exited.

An additional mechanism for entering the admin screen is via pressing the “Esc” key on the physical keyboard that is connected to the digital jukebox computer system 110i The rationale is that any user that has access to the physical keyboard is inherently a privileged user, as it is intended for the computer system to be housed in a locked enclosure, in which the only input a user normally has with the system is via the touch screen interface and bill acceptor.

FIG. 9 depicts the display of admin screen 900. Admin screen 900 is comprised of the following elements: (a) delete 901, at upper left-hand corner of the screen; (b) add to queue 902, below delete 901; (c) remove from queue 903, below add to queue 902; (d) reset statistics 904, below remove from queue 903; (e) expand tree 905, below from reset statistics 904; (f) collapse tree 906, below expand tree 905; (g) show duplicates 907, below collapse tree 906; (h) player volume 908, below show duplicates 907; (i) minimum queue size 909, below player volume 908; (j) show queued 910, immediately to the right of minimum queue size 909; (k) random play interval 911, below minimum queue size 909; (I) play random songs 912, immediately to the right of random play interval 911; (m) acceptor statistics 913, to the right of elements 909-912 and near the center of the screen; (n) show confirmations 914, below acceptor statistics 913; (o) jukebox tree 915, immediately to the right of elements 901-908, and extending to the center of the screen; (p) song queue 916, immediately to the right of jukebox tree 915; (q) play next 917, at the upper right-hand corner of the screen; (r) pause current 918, below play next 917; (s) play now 919, below pause current 918; (t) move up 920, below pause current 919; (u) move down 921, below move up 920; (v) remove 922, below move down 921; (w) remove all 923, below remove 922; (x) increment 924, below remove all 923; (y) decrement 925, below increment 924; (z) scan for songs 926, below decrement 925; (aa) load playlist 927, below scan for songs 926; (bb) save playlist 928, below load playlist 927; (cc) log file history 929, to the left of elements 926-928; and (dd) time remaining 930, below log file history 929 and to the immediate left of save playlist 928.

Button elements 901-907 operate on jukebox tree 915, which displays the contents of the CD library in the form of a tree structure. This tree matches that of the actual file system tree structure on hard drive 130. When a user selects an entry in jukebox tree 915, the following can occur:

(a) A privileged user with owner-level access can click on delete 901 in order to delete the selected entry, and any sub-entries that it can contain, from hard drive 130.

(b) A privileged user can click on add to queue 902 in order to add any songs that the selected entry, and any sub-entries that it can contain, to the song queue. That is, if the selected entry is the name of an artist for example, all songs for all CDs that that artist has in the CD library are added to the song queue.

(c) A privileged user can click on remove from queue 903 in order to remove any songs that can exist in the song queue that are from the selected entry, and any sub-entries that it can contain. That is, if the selected entry is the name of a genre, then all songs that are part of a CD whose genre is the same as the selected entry, are removed from the song queue.

(d) A privileged user can click on reset statistics 904 in order to change the play count of any songs that the selected entry, and any sub-entries that it can contain, to zero. Performing this action removes any songs or CDs from one or more of the table displays for popular screen 600. Furthermore, for songs that are reset, no longer display a play frequency icon until they are requested again.

A privileged user can click on expand tree 905, regardless of whether a selection has been made in jukebox tree 915, in order to show the tree in its default, fully expanded state, as the tree must be expanded in order for the graphic user interface of the invention to operate properly. When the tree is fully expanded, all nodes are shown such that the leaf entries, or song entries, are visible.

A privileged user can click on collapse tree 906, regardless of whether a selection has been made in jukebox tree 915, in order to hide all the song entries, leaving only the nodes corresponding to genres, artists, and cd titles visible. The purpose of this action is to allow a user to traverse the contents of the tree quickly.

A privileged user with owner-level access can click on show duplicates 907 in order to bring up a dialog window that shows all of the duplicate song entries that exist in the CD library. On this dialog window, a user can select one of the two duplicates, then press a “delete” button in order to remove the duplicate song from hard drive 130. The purpose of this action is to allow a user to free up space on hard drive 130 by removing duplicate songs.

Elements 908-912 and 913 are related to the user-friendly aspects for the configuration of the graphic user interface of the invention. Some of these elements employ a custom control called a spin button. A spin button is a control that has a read-only text field and two arrow buttons next to it. one atop another. The top button is of an arrow pointing up and when clicked on, increments the numerical value that is displayed in the entry field. Similarly, when the bottom button, which displays an arrow pointing down, is clicked on, the value in the entry field is decreased. The range of values varies with each control. Thus the elements of the admin screen 900, related to configuration are:

(a) player volume 908 is a spin button that allows a privileged user to control the gain, or volume, of the player that sends its output to sound card 160. A user can choose a value for the volume to be from zero to one-hundred inclusive.

(b) minimum queue size 909 is a spin button that allows a privileged user to control how many songs are in the song queue at a minimum. That is, if no patrons are requesting songs, a user with access to admin screen 900 can use this settings to effectively turn on continuous random play. Changing the minimum queue size allows a user to see which songs are queued up, so as to give him/her a chance to remove that song if they wish.

(c) show queued 910 is a check box that allows a privileged user to configure whether or not a different icon, appearing as a “Q”, is displayed n the place of the normal play frequency icon 280 of CD panel 270, as shown in FIG. 3, for those songs that are queued to be played. The default setting does not show which songs are queued to the non-privileged user browsing through the various screens.

(d) random play interval 911 is a spin button that allows a privileged user to configure, in minutes, how often a random song is played by the invention when there aren't any songs being played currently. That is, if a song is already being played when this time interval is up, then a random song is not added to the song queue, and the timer starts at zero again. The range of values for this interval is twenty minutes to one-hundred eighty minutes.

(e) play random songs 912 is a checkbox that allows a privileged user to configure whether or not to play a random song at the time interval specified by random play interval 911. When this check box is not set, random play interval 911 is made to display invisibly.

(f) show confirmations 914 is a check box that allows a privileged user to configure whether or not to display confirmation dialog 1000 when a normal user selects a song to be played using either home screen 400, search screen 500, popular screen 600, or genre screen 700. Not having this set, allows songs to be automatically added to the song queue from these screens either by double-clicking on the song entry in listbox 275 of CD panel 270, or by single-clicking on the song entry or entering the selection number manually on the control panel, and then clicking on enter 342 of the control panel. The default setting for the invention is to show this confirmation dialog, as there is advertising images that are displayed.

“Acceptor statistics” 913 is a table that allows a privileged user to view the history, month-to-month, of the dollar amount collected by bill acceptor 150 since the inception of the graphic user interface of the invention running on digital jukebox computer system 110. The first column of the table, month/year 913-A, shows the month and year of the entry in the form of a 3-digit abbreviation for the month and the 4-digit numerical year. For example, a typical entry for column one might look like: “Jun2001”. The second column of the table, amount 913-B, shows the dollar amount collected by the bill acceptor. For example, a typical entry for column two might look like: “$525”. The way a single line of this table would be interpreted using this example is that $525 was collected for the month of June, 2001.

Song queue 916 is a list box that corresponds to the queue that exists for songs that are going to be played. These songs are added either explicitly by a non-privileged user using a credit, a privileged user using “add to queue” 902, or randomly by the graphic user interface of the invention. Buttons 917-928 all operate in some fashion on song queue 916. Song queue 916 is dynamic, whereas jukebox tree 915 is essentially static. Another difference between the two is that any songs that exist in song queue 916 are a subset of the songs that exist in jukebox tree 915.

A privileged user is allowed to click on play next 917 at any time. When this happens, the currently playing song is immediately stopped and the next song in the queue is played next, if one exists. If there isn't a currently playing song, then it necessarily implies that there will also be no further entries in song queue 916. In this case, clicking on play next 917 causes nothing to happen.

A privileged user is allowed to click on pause current 918 at any time. When this happens, the currently playing song is paused indefinitely. A user must click on pause current 918 once more in order to resume playing the currently paused song. If there isn't a currently playing song, then nothing happens when pause current 918 is clicked on.

If a song entry is highlighted in song queue 916, and a privileged user clicks on play now 919, then the highlighted song is immediately played, regardless of its position in the queue and whether or not another song is currently playing. If there is not a highlighted song entry in song queue 916, then nothing happens when pause current 918 is clicked on.

If a song entry is highlighted in song queue 916, and a privileged user clicks on move up 920, then the highlighted song is moved up one place in the queue. That is, if the highlighted song is the third entry in song queue 916, then it switches location with the second entry. If there isn't a highlighted song entry in song queue 916, then nothing happens when move up 920 is clicked on.

If a song entry is highlighted in song queue 916, and a privileged user clicks on move down 921, then the highlighted song is moved down one place in the queue. That is, if the highlighted song is the third entry in song queue 916, then it switches location with the fourth entry. If there isn't a highlighted song entry in song queue 916, then nothing happens when move down 921 is clicked on.

If a song entry is highlighted in song queue 916, and a privileged user clicks on remove 922, then the highlighted song is removed from the queue. That is, that instance of the highlighted song will not be played. If there are other instances of the same song, then they remained unchanged in the song queue. If there isn't a highlighted song entry in song queue 916, then nothing happens when remove 922 is clicked on.

A privileged user is allowed to click on remove all 913 at any time. When this happens, all entries from the song queue are removed. If there is a song that is currently playing, then that song will continue playing. If there aren't any entries in song queue 916, then nothing happens when remove all 923 is clicked on.

A privileged user with owner-level access is allowed to click on increment 924 at any time. When this happens, the number of credits that is available to a non-privileged user increases by one. This action has the effect of not requiring a privileged user to insert money into the bill acceptor in order to select songs to play.

A privileged user with owner-level access is allowed to click on decrement 925 at any time. When this happens, the number of credits that is available to a non-privileged user decreases by one.

A privileged user with owner-level access is allowed to click on scan for songs 926 at any time. When this happens, any song that is currently playing is paused, then the graphic user interface of the invention performs a scan of any hard drives, specified by the “ScanPaths” configuration parameter that is specified in the Examples, for any new encoded CDs that are in the proper format, as specified in the Examples, that have been added to hard drive 130 since the last time scan for songs 926 was clicked on. While this is occurring, a progress dialog box appears on-screen, giving the user a measure of how long this operation can take.

A privileged user can click on load playlist 927 in order to load a file from disk that is in a format recognized by the graphic user interface of the invention as a play list. A playlist is a list of songs that can be added to song queue 916. This operation has the effect of allowing a privileged user to add a pre-defined list of songs to the song queue in order to quickly insert songs into song queue 916.

A privileged user can click on save playlist 928 in order to save the contents of song queue 916 to a file on disk that later be loaded using load playlist 927. is in a format recognized by the graphic user interface of the invention as a play list.

A privileged user is allowed to view a log file history 929, a text area that contains milestone information such as configuration parameters and events such as: when a user inserts money into bill acceptor 150, when a user makes a song selection, and when a song is taken from the song queue and played.

A privileged user is allowed to view time remaining 930, a text field which shows how much time is remaining for the currently playing song. The format for this field is MM:SS, where MM is the minutes portion and SS is the seconds portion of the time remaining. If there isn't a currently playing song, then this field is blank.

FIG. 10 depicts the display of confirmation dialog 1000, which is comprised of banner ad image 1001 in the top center, selected song 1002 in the center below banner ad image 1001, button yes 1003 below selected song 1002 and offset to the left-center, and button no 1004 to the right of yes 1003.

Banner ad image 1001 displays a series of images that are kept in the “bannerads” directory that is a part of the file structure for the graphic user interface of the invention. Images that are to be displayed do not have to have any special names, they just need to be at most 470 pixels wide and 200 pixels high and in the graphics format known as “GIF”. Selected song 1002 contains the name of the song that is selected by a user to play. Yes 1003 is a button, that when clicked, serves as a confirmation that the user does indeed wish to hear the song displayed in selected song 1002. For this case, the dialog is dismissed, the song is added to song queue 916, and the number of credits is decreased by one. Otherwise, if the user clicks on no 1004, then this is interpreted as the user not wanting to hear the song displayed in selected song 1002. For this case, the dialog is dismissed, the song is not added to song queue 916, and the number of credits remain the same. In either case, the user has viewed banner ad image 1001, which can be any image, such as external advertising or in-house promotions. The number of viewings for each image is stored in the file named: “BannerAdShowCount.properties”, which is in the same directory on disk as the graphic user interface of the invention. The information stored in this file can be used as feedback in which to assist a user in determining how many times each image has been displayed.

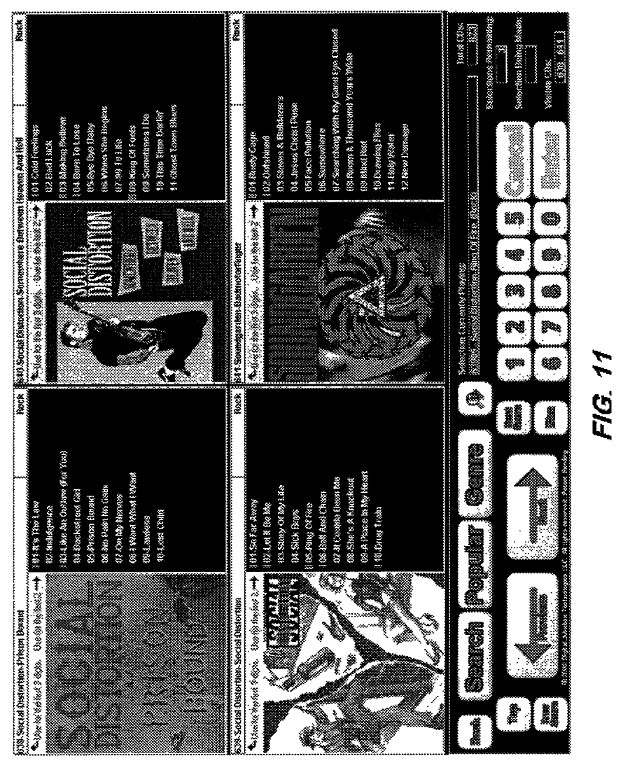

FIG. 11 shows a screen capture representation of home screen 400 at a 50% reduction. The state of the application at this point is as follows:

(a) The four visible CDs are: CD number 638, Social Distortion's “Prison Bound” with 10 tracks available in northwest CD panel 410, CD number 639, Social Distortion's “Social Distortion” with 10 tracks available in southwest CD panel 420, CD number 640, Social Distortion's “Somewhere Between Heaven And Hell” with 11 tracks available in northeast CD panel 430, and Sound Garden's “Badmotorfinger” with 12 tracks available in southeast CD panel 440. This is shown in visible CDs 355.

(b) The four visible CDs are of the “Rock” genre.

(c) The first track of CD number 638, whose unique 5-digit number is 63801, has been played at least once, and is showing image 1 for song play frequency icon 280, as are 63803, 63901, 63902, 63906, 63910, 64001, 64004, and 64102.

(d) Songs 63905, 64003, and 64101 have been played more than the above songs and are showing image 2 for song play frequency icon 280.

(e) Song 64008 has been played more than any other song that is visible on the screen and is showing image 3 for song play frequency icon 280.

(f) Song 63905, Social Distortion's “Ring Of Fire” is the currently playing song, as is shown in current song 351.

(g) All the scrolling buttons are enabled and allow for navigation as labeled on the buttons.

(h) The screen buttons are enabled and allow for viewing the search screen, popular screen, or the genre screen. If the user clicks in the lower left-hand corner of the control panel, then the logon screen would be displayed.

(i) There are 823 CDs in the CD library, as shown in total CDs 352.

(j) There are 3 credits, as shown in selections remaining 353.

(k) Since selection being made 354 is blank, the numbered selection buttons are enabled, the enter button is disabled, and the cancel button is disabled.

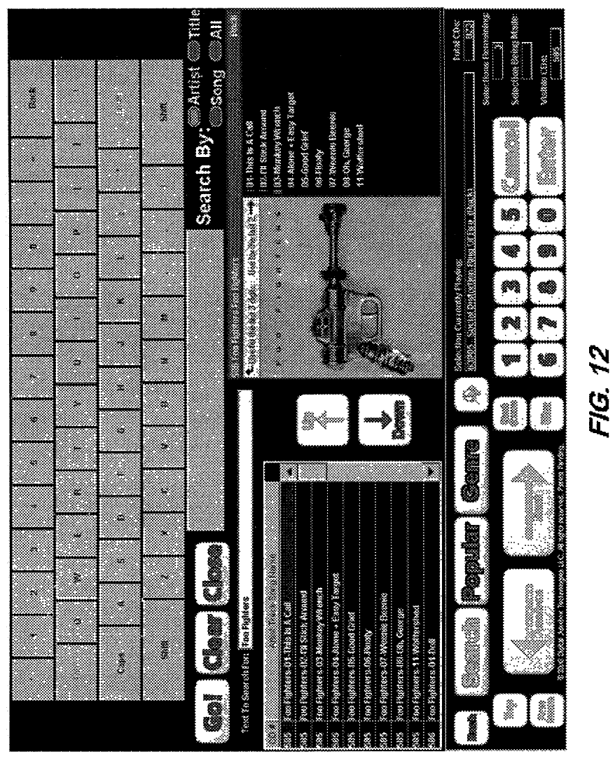

FIG. 12 shows a screen capture representation of search screen 500 at a 50% reduction. The state of the application at this point is as follows:

(a) A user has performed a search on the text “Foo Fighters”, as shown in search text field 562 and search results 565.

(b) The first song displayed in search results 565 is “Foo Fighters-01-This Is A Call”, which is from CD number 586, as is shown in search CD panel 566.

(c) The CD shown in search CD panel 566, is considered to be a “new” CD by virtue of the fact that it has a red border.

(d) The search was done on a “by artist” basis, as shown in search by button field artist 558.

(e) A user is able to scroll down the search results 565 table, but not up.

(f) A user is not able to use the scrolling buttons on the control panel.

(g) A user is able to switch to the popular screen, genre screen, by clicking on the respective buttons.

(h) A user is able to return to the home screen by clicking on close 557.

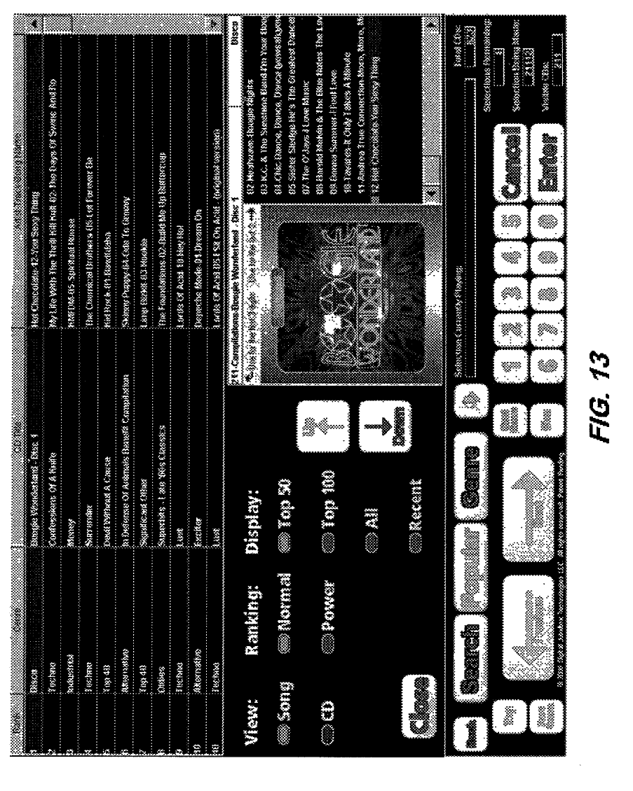

FIG. 13 shows a screen capture representation of search screen 600 at a 50% reduction. The state of the application at this point is as follows:

(a) The listing in table 601 shows the top 50, normally ranked songs, as song 602, normal 604, and top 50 606 are in the set state.

(b) The most popular normally ranked song is “You Sexy Thing” by Hot Chocolate.

(c) “You Sexy Thing” by Hot Chocolate is from the CD numbered 211 and labeled “Boogie Wonderland—Disc 1” and is a compilation CD as defined in the Examples, is of the “Disco” genre, and is shown in popular CD panel 612.

(d) The top 10 normally ranked songs are visible in table 601. The table can be scrolled down using either down 611 or the vertical scrollbar shown in table 601.

(e) A user is able to return to the home screen by clicking on close 613.

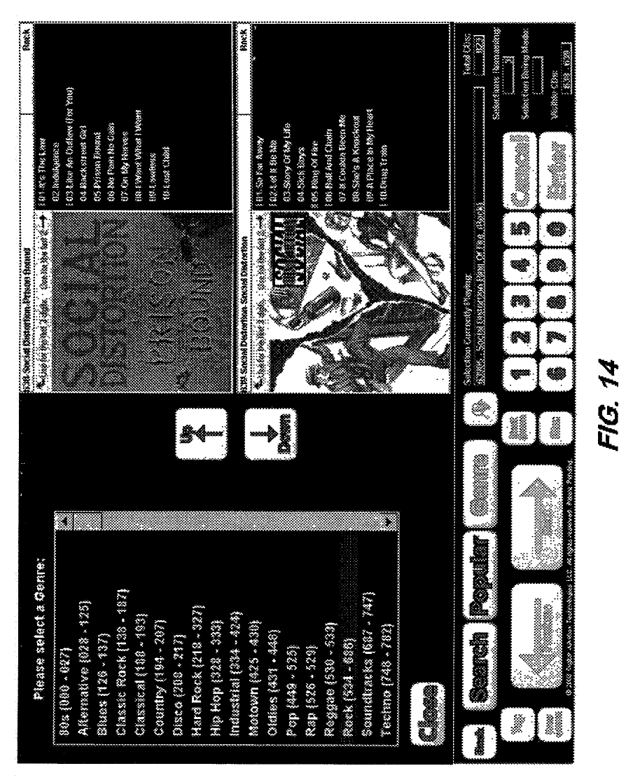

FIG. 14 shows a screen capture representation of genre screen 700 at a 50% reduction. The state of the application at this point is as follows:

(a) There are 18 genres listed in genre listbox 701.

(b) The currently highlighted genre is “Rock” and the currently visible “Rock” CDs are the CDs numbered 638, Social Distortion's “Prison Bound” and 639, Social Distortion's “Social Distortion”, displayed in genre north CD panel 704 and genre south CD panel 705.

(c) A user can scroll through the previous or next CDs in the “Rock” genre by clicking on up 702 and down 703, respectively.

(d) A user is able to return to the home screen by clicking on close 706.

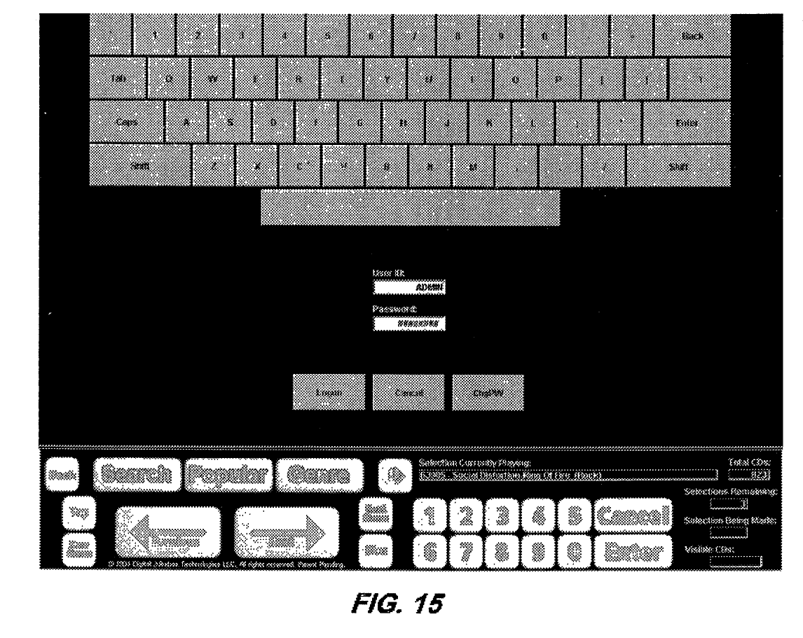

FIG. 15 shows a screen capture representation of logon screen 800 at a 50% reduction. The state of the application at this point is as follows:

(a) A user has entered the user ID “ADMIN” in the user id 801 text field.

(b) A user has entered an eight-digit password in the password 802 text field.

(c) A user can enter admin screen 900 by clicking on logon 803, if and only if, the entered password is the same as that which is encrypted into the file “AdminPwd.ctl”, using the MD5 encryption algorithm.

(d) A user can change the password by clicking on change password 805, if the entered password is the same as that which is encrypted in the above file.

(e) A user is able to return to the home screen by clicking on cancel 804.

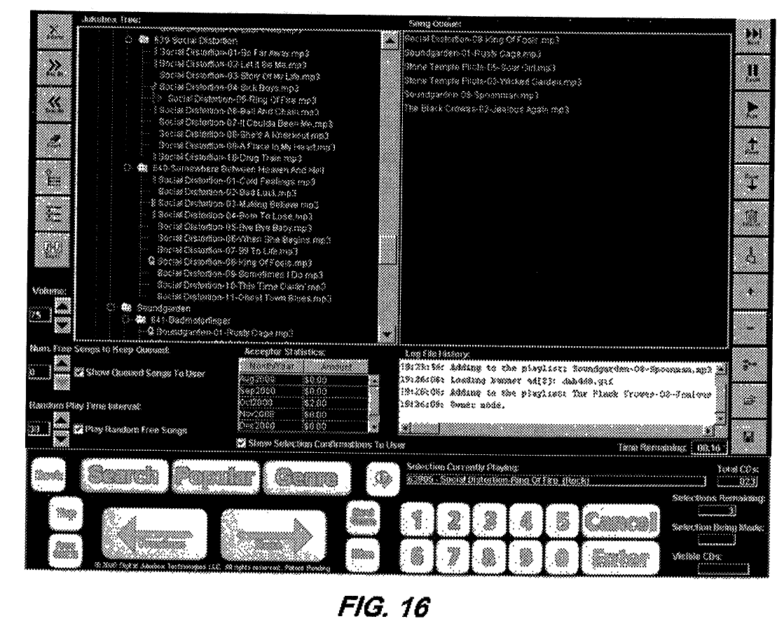

FIG. 16 shows a screen capture representation of admin screen 900 at a 50% reduction. The state of the application at this point is as follows:

(a) A privileged user can view the contents of song queue 916, in which the next song queued to play is “King Of Fools”, by Social Distortion.

(b) A privileged user can modify the contents of song queue 916, by clicking on the appropriate buttons, as described previously.

(c) A privileged user can modify the configuration of the graphic user interface of the invention by manipulating player volume 908, minimum queue size 909, show queued 910, random play interval 911, play random songs 912, and show confirmations 914.

(d) A privileged user can view the monthly amounts of money taken in by bill acceptor 150 by viewing acceptor statistics 913.

(e) A privileged user that doesn't have owner-level access will not be able to access delete 901, show duplicates 907, increment 924, decrement 925, and scan for songs 926.

(f) A privileged user can view the time remaining for the currently playing song, which is displayed in time remaining 930.

(g) A privileged user can view the contents of the log file, “MP3Jukeboxx.log”, which is displayed in log file history 929.

(h) A privileged user is able to return to the home screen by clicking on logon screen 324, which is not displayed as a normal button, but is located to the right of selection being made 354 in the lower left-hand corner of the control panel.

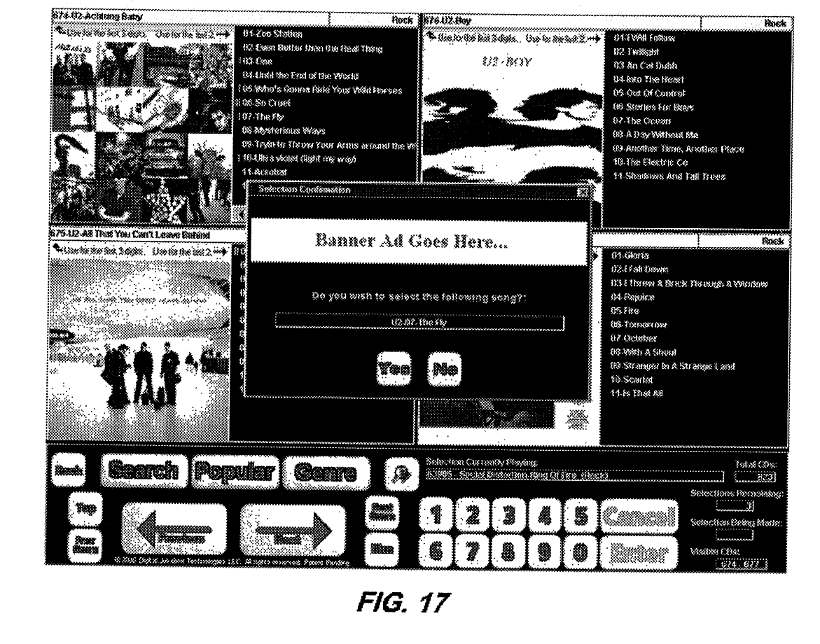

FIG. 17 shows a screen capture representation of confirmation dialog 1000 at a 50% reduction. The state of the application at this point is as follows:

(a) A user has just clicked on enter 342, and has selected to play “The Fly” by U2, as is shown in selected song 1002.

(b) An image is displayed in banner ad image 1001.

(c) A user can commit the selection by clicking on yes 1003, whereby the number of credits, as shown in selections remaining 353, will be decreased by one.

(d) A user can cancel the selection by clicking on no 1004, whereby the number of credits will remain the same, as shown in selections remaining 353.

The invention is further described in detail by reference to the following examples. These examples are provided for the purpose of illustration only, and are not intended to be liming unless otherwise specified. Thus, the invention should in no way be construed as being limited by the following examples, but rather should be construed to encompass any and all variations which become evident as a result of the teaching provided herein.

### EXAMPLES

### Example 1

Digital jukebox computer system 110 can be comprised of a personal computer system that has the following software installed: Sun Microsystem's Java™ 2 Platform, Standard Edition v 1.3.0 or greater for running the graphic user interface 120, Sun Microsystem's Java™ Communications API v 2.0 or greater for interfacing with bill acceptor 150, and Sun Microsystem's Java™ Media Framework API v 2.0 or greater for reading song files in the MP3 format from hard drive with encoded CDs 130 and rendering them into an appropriate audio stream for sound card 160. Optionally, digital jukebox computer system 110 can also be comprised of Nullsoft's Winamp software MP3 player and various Winamp plugins to improve sound quality in order to read song files in the MP3 format from hard drive with encoded CDs 130 and render them into an appropriate audio stream for sound card 160.

The graphic user interface 120 constructed in accordance with the invention, is a Java application comprised of the following binary files that are executed by the Java Virtual Machine that runs on digital jukebox computer system 110:

1. CDPanel$1.class

2. CDPanel$2.class

3. CDPanel$3.class

4. CDPanel.class

5. ConfirmationDialog.class

6. DupeSongFinder$SongEntry.class

7. DupeSongFinder.class

8. Exec$StreamHandler.class

9. Exec.class

10. FileChooserFilter.class

11. FileChooserView.class

12. GBAMgr$GBAMessage.class

13. GBAMgr.class

14. JmfMgr.class

15. KeyboardPanel.class

16. LogonDialog.class

17. Md5File.class

18. MP3Jukebox$1.class

19. MP3Jukebox$2.class

20. MP3Jukeboxx$3.class

21. MP3Jukebox$4.class

22. MP3Jukeboxx$5.class

23. MP3Jfsukeboxx$6.class

24. MP3Jukebox$7.class

25. MP3Jukeboxx$8.class

26. MP3Jukeboxx$9.class

27. MP3Jukeboxx.class

28. MyListRenderer.class

29. MyRenderer.class

30. PlayerMgr.class

31. ProgressFrame$CubbyHole.class

32. ProgressFrame.class

33. SpinButton.class

34. TomArrowButton.class

35. TomScrollBar.class

36. TomScrollBarUI$ArrowButtonListener.class

37. TomScroliBarUI$ModelListener.class

38. TomScrollBarUI$PropertyChangeHandler.class

39. TomScrollBarUI$ScrollListener.class

40. TomScrollBarUI$SharedActionScroller.class

41. TomScrollBarUI$TrackListener.class

42. TomScrollBarUI.class

43. TreeMgr$PlayListEntry.class

44. TreeMgr.class

45. WinampFilter.class

46. WinAmpMgr.class

In order to create these binary files, it is necessary to compile the following Java programming language source files that are listed as follows:

1. CDPanel.java

2. ConfirmationDialog.java

3. CustomFileView.java

4. DupeSongFinder.java

5. Exec.java

6. FileChooserFilter.java

7. FileChooserView.java

8. GBAMgr.java

9. JmfMgr.java

10. KeyboardPanel.java

11. LogonDialog.java

12. Md5File.java

13. MP3Jukeboxx.java

14. MyListRenderer.java

15. MyRenderer.java

16. PlayerMgr.java

17. ProgressFrame.java

18. SpinButton.java

19. TomArrowButton.java

20. TomScrollBar.java

21. TomScrollBarUI.java

22. TreeMgr.java

23. WinampFilter.java

24. WinAmpMgr.java

The source files that comprise the graphic user interface of the invention can be placed into any directory on the personal computer, although this directory name can be “kiosk”. The command needed to initialize the CLASSPATH environment variable needed to use the Java compiler and subsequently run the graphic user interface of the invention on Windows based operating systems is: “SET CLASSPATH=.;c:\jmf2.1.1\lib\sound.jar;c:\jmf2.1.1\lib\jmf.jar;c:\jdk1.3\lib\comm.jar;”The command needed to initialize the PATH environment variable needed to use the Java compiler and subsequently run the graphic user interface of the invention on Windows based operating systems is:

“SET PATH=c:\bin;c:\jdk1.3\bin;c:\jdk1.3\jre\bin;%PATH%”

The command for compiling the source files on Windows based operating systems is:

“javac MP3Jukeboxx.java”.

The command for running the source files on Windows based operating systems is:

“start “JukeANator”/REALTIME java MP3Jukebox”.

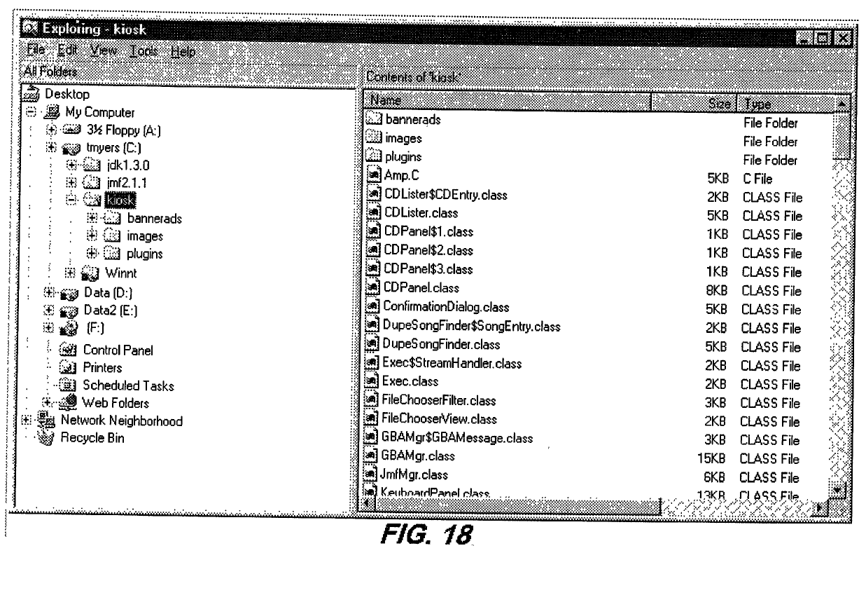

The file structure for the graphic user of the interface is shown in FIG. 18. The java class files shown above can be placed in the directory, “C:\kiosk”. There are three subdirectories underneath this directory: “bannerads”, “images”, and “plugins”. Banner advertising images, which are in the .GIF format and are the standard 468×60 pixel size, can be placed in the “bannerads” sub-directory so that they can be displayed in banner ad image 1001 on confirmation dialog 1000 when a user selects a song to play.

The graphics images for the graphic user interface of the invention are placed in the “images” sub-directory. They are enumerated alphabetically, along with what element they correspond to on the graphic user interface of the invention, as follows:

[image]

[image]

[image]

[image]

[image]

[image]

[image]

[image]

[image]

[image]

[image]

[image]

[image]

[image]

[image]

[image]

[image]

[image]

### Example 2

The file, “MP3Jukeboxx.properties”, is located in the same directory where the program files for the graphic user interface of the invention are located. The contents of this file contain the configuration parameters for the graphic user interface of the invention, and can consist of something similar to the following:

Line #:

1 #Juke-A-Nator Configuration File

2 #Mon Jun 11 20:18:27 EDT 2001

3 NumberToQueue=0

4 BannerAdIndex=6

5 NewCDAgeThreshold=90

6 NewCDVectorSize=100

7 NewSongVectorSize=50

8 ShowQueued=true

9 ShowConfirmation=true

10 Credits=9

11 RandomPlayInterval=30

12 RandomPlay=false

13 PlayerVolume=75

14 SongPlayer=winamp

15 CreditsPer=3

16 BonusFactor_1=1

17 BonusFactor_2=3

18 BonusFactor_3=5

19 BonusFactor_4=7

20 Level_2=6

21 Level_1=3

22 Level_0=0

23 FlipToRandom=true

24 ScanPaths=D,E

Lines 1 and 2 are comment lines. They serve no purpose other than to describe the file to a human reader. Line 1 refers to the file as being the configuration file for the graphic user interface of the invention. Line 2 refers to the time-stamp when the file was last saved.

“NumberToQueue” on line 3 determines what value to use for the minimum queue size 909 spin button on admin screen 900. The initial value for this parameter is 0. The range for this parameter is from 0 to 25.

“BannerAdIndex” on line 4 determines the index of the banner ad image to use upon startup. The purpose of this parameter is to ensure that lower-indexed banner ads are not shown more often than higher indexed banner ads. The initial value for this parameter is 0. The range for this parameter varies from 0 to the number of files that exist in the “bannerads” directory.

“NewCDAgeThreshold” on line 5 determines the age threshold, in days, for what is treated as a new CD by the graphic user interface of the invention. The CD panels for new CDs are painted with a red border, instead of a white border. The initial value for this parameter is 30. The suggested range for this parameter is from 0 to 180.

“NewCDVectorSize” on line 6 determines the size of the list of newest CDs for popular screen 600. Specifically, this parameter determines the size of table 601, when buttons CD 603 and new/recent 609 are set. If the number of CDs in the CD library that are considered new by NewCDAgeThreshold is less than the value of this parameter, then the list of new CDs for table 601 will be this number. The initial value for this parameter is 50. The suggested range for this parameter is from 0 to 150.

“NewSongVectorSize” on line 7 determines the size of the list of most recently played songs for popular screen 600. Specifically, this parameter determines the size of table 601, when buttons song 602 and new/recent 609 are set. The initial value for this parameter is 50. The suggested range for this parameter is from 0 to 150.

“ShowQueued” on line 8 determines whether or not the show queued 910 check box on admin screen 900 is checked or not. When in a checked state, the value for show queued 910 is true, false otherwise. The initial value of this configuration parameter is true. It can only be true or false. Anything other than true will be considered to be false.

“ShowConfirmation” on line 9 determines whether or not the show confirmations 914 check box on admin screen 900 is checked or not. When in a checked state, the value for show confirmations 914 is true, false otherwise. The initial value for this configuration parameter is true. It can only be true or false. Anything other than true will be considered to be false.

“Credits” on line 10 determines the value to use on startup for selections remaining 353 on control panel 300. The purpose of this parameter is to remember the number of credits previously existing during the last execution of graphic user interface of the invention. Typically though, this value is 0. The initial value for this parameter is 0. The range for this parameter is from 0 to 2³².

“RandomPlayInterval” on line 11 determines what value to use for the random play interval 911 spin button on admin screen 900. The initial value for this parameter is 20. The range for this parameter is from 20 to 120.

“RandomPlay” on line 12 determines whether or not the play random songs 912 check box on admin screen 900 is checked or not. When in a checked state, the value for show play random songs 912 is true, false otherwise. The initial value for this configuration parameter is true. It can only be true or false. Anything other than true will be considered to be false.

“PlayerVolume” on line 13 determines what value to use for the player volume 908 spin button on admin screen 900. The initial value for this parameter is 75. The range for this parameter is from 0 to 100.

“SongPlayer” on line 14 determines which MP3 player will be used in order to create an audio stream for sound card 160 in digital jukebox computer system 110. There are two choices: “winamp” or “JMF”. Winamp, is a licensed product from Nullsoft, Inc. JMF, or Java Media Framework is a code framework from Sun Microsystems that facilitates the development of multimedia Java applications. The graphic user interface of the invention has a built-in MP3 player that uses JMF. The initial value however, for this configuration parameter is “winamp”, because on Windows-based systems, the CPU resource requirements and audio quality are somewhat better with winamp.

“CreditsPer” on line 15 determines the number of credits that is that is added to selections remaining 353 on control panel 300 each time a user enters a $1 bill to bill acceptor 150 of digital jukebox computer system 110. The initial value for this parameter is 4. The suggested range is from 1 to 5.

“BonusFactor_{—}1” on line 16 determines the number of bonus credits to be added to selections remaining 353 on control panel 300 each time a user enters a $2 bill to bill acceptor 150 of digital jukebox computer system 110. That is, in addition to the credits that is to be added for entering the $2 bill in the first place. For example, if the value of BonusFactor_1 is 1, CreditsPer is 4, and the number of credits is initially 0, then when a user enters a $2 bill into the acceptor, then there will be 2×4+1, or 9, credits afterwards. The purpose of this parameter is to encourage a user to enter more money at any one time, as that user gets more credits per dollar, when they enter more. The initial value of this parameter is 1. The suggested range of this parameter is from 0 to 5.

“BonusFactor_{—}2” on line 17 determines the number of bonus credits to be added to selections remaining 353 on control panel 300 each time a user enters a $5 bill to bill acceptor 150 of digital jukebox computer system 1110. That is, in addition to the credits that is to be added for entering the $5 bill in the first place. The initial value of this parameter is 3. The suggested range of this parameter is from 0 to 10.

“BonusFactor_{—}3” on line 18 determines the number of bonus credits to be added to selections remaining 353 on control panel 300 each time a user enters a $10 bill to bill acceptor 150 of digital jukebox computer system 110. That is, in addition to the credits that is to be added for entering the $10 bill in the first place. The initial value of this parameter is 5. The suggested range of this parameter is from 0 to 15.

“BonusFactor_{—}4” on line 19 determines the number of bonus credits to be added to selections remaining 353 on control panel 300 each time a user enters a $20 bill to bill acceptor 150 of digital jukebox computer system 110. That is, in addition to the credits that is to be added for entering the $20 bill in the first place. The initial value of this parameter is 7. The suggested range of this parameter is from 0 to 15.

“Level_{—}2” on line 20, “Level₁₃ 1” on line 21, and “Level₁₃ 0” on line 22, are all related in that they determine which play frequency image to display next to a song entry in the song listbox of a given CD panel. The initial value of Level_2 is 6. The initial value of Level_1 is 3. The initial value of Level_1 is 0. The suggested range of values for these parameters are from 0 to 500, yet with the condition that Level_0 is less than Level_1 and Level₁₃ 1 is less than Level_2.

If the play frequency of a song is greater than, or equal to, the value of Level_2, then image 3 will be displayed next to the song entry. Image 3 can consist of 3 bars to indicate a very highly played song.

If the play frequency of a song is greater than, or equal to, the value of Level_1 and less than the value of Level_2, then image 2 will be displayed next to the song entry. Image 2 can consist of 2 bars to indicate a highly played song.

If the play frequency of a song is greater than the value of Level_0 and less than the value of Level_1, then image 1 will be displayed next to the song entry. Image 1 can consist of 1 bar to indicate a song that is played with normal-frequency.

If the play frequency of a song is equal to the value of Level_0, then image 0 will be displayed next to the song entry. Image 0 can consist of a blank image to indicate a song that is either has seldom played, or never been played at all.

“FlipToRandom” on line 23 determines whether or not a flag is set that causes a random page of CD panels is displayed on home screen 400 when the graphic user interface of the invention is started. The purpose of this parameter is to display a variety of initial screens, instead of the first four CD panels that are found in the CD library. When this flag is set to true, a random page will be displayed on home screen 400. Otherwise, when set to false, the first four CD panels are displayed. The initial value for this configuration parameter is true. It can only be true or false. Anything other than true will be considered to be false.

“ScanPaths” on line 24 determines the list of hard drives from digital jukebox computer system 110, that is considered to be hard drive with encoded CDs 130. That is, the graphic user interface of the system will only search through the drives listed for ScanPaths when a privileged user with owner-level access clicks on scan for songs 926 on admin screen 900. The initial value for this parameter is D. Any further drives to be scanned are added at the end of this parameter, separated by a comma. For example, to scan in drives D, E, and F, the value of this parameter is “D,E,F”.

### Example 3

In order for the graphic user interface of the invention to operate in an intuitive manner for a user as described above, hard drive with encoded CDs 130 should be constructed and laid out in a manner as described below:

Step 1: Purchase Audio CD

A user can purchase, or already have in their possession, an audio CD suitable for inclusion into hard drive 130.

Step 2: Convert Audio CD to Digitally Encoded Form

With the audio CD, there are different options with which to convert the audio tracks into the MP3 format. Not only are there different commercial products such as RealJukebox, there are many freeware/shareware MP3 “rippers” available from the internet that can be used to convert an audio CD into digitally encoded form, namely, using the MP3 format.

The bitrate, or bits of information per second, at which these audio tracks are converted can vary. “CD Quality” is defined as a minimum of 128Kbps. The higher the bitrate, the better the music quality will be, although the improvements are subjective to the individual listener the user can opt for the minimal 128 Kbps bitrate in order to maximize the amount of encoded CDs that can be stored on hard drive 130.

Step 3: Name the Encoded Audio Tracks

The naming convention that should be used for the proper operation of the graphic user interface of the invention is:

Artist-xx-Song Name.mp3

where:

a. Artist is the name of the recording artist of the CD.

b. xx is the track number of the song as it is found on the CD from which it was “ripped” from.

c. Song Name is the name of the song as described in the CD liner notes.

d. .mp3 is the file extension denoting that this file is in the MP3 format.

e. The artist and track number are separated by the “-” character.

f. The track number and song name are separated by the “-” character.

Step 4: Creation of Digital CD Cover Art

In addition to encoding the audio tracks of a particular audio CD, the cover art can be represented as a digitally encoded image file, specifically a 250 by 250 pixel JPEG image, using the name “cover.jpg”. As with MP3 converters, there are different ways to accomplish this task. One way is to use a digital scanner, while another is to download and re-size the image from internet web-sites such as Amazon. The compression factor, which affects image quality, can be configured to suit the taste of the user.

Step 5: Create Appropriate Directory on Hard Drive

The encoded CD, which consists of a set of a set of encoded songs and cover art, as described above, is then placed into a directory onto the hard drive using another naming/directory structure convention. First, it is necessary for the user to subjectively define which “genre” of music that this encoded CD can be categorized under. Given this, the following textually represented tree structure shows the relationship between this genre and the encoded audio CD:

```
D:\
|
Genre One\
| |
| Compilations\
| | |
| | CD Title One
| | .
| | .
| | .
| | CD Title n
| Artist One\
| | |
| | CD Title One
| | .
| | .
| | .
| | CD Title n
. .
. .
. .
| Artist n\
| |
| CD Title One
| .
| .
| .
| CD Title n
|
Genre n\
| |
| Compilations\
| | |
| | CD Title One
| | .
| | .
| | .
| | CD Title n
| |
| Artist One\
| | |
| | CD Title One
| | .
| | .
| | .
| | CD Title n
| .
| .
| .
| Artist n\
| |
| CD Title One
| .
| .
| .
| CD Title n
|
Soundtracks\
                        |
                        CD Title One
                        .
                        .
                        .
                        CD Title n
```

As shown above for a hard drive known as “D:”, the following rules of thumb for creating a directory structure is as follows:

1. For each “genre” of music, a new directory is created from the root directory of the hard drive that is to store the encoded CD that are considered to be of that genre of music.

2. For each artist classified under a particular genre, a new directory from that genre's directory, is created. In addition, for each genre, a new directory is created called “Compilations” that is used to hold CDs for which there is no singular artist responsible for all of the music on the CD. In addition, if there is a “Soundtracks” genre that is created from the root directory, there is no need to create artist directories as this genre is specifically recognized by the graphic user interface of the invention as a special genre in that it is inherently comprised of compilation CDs.

3. For each encoded CD that is performed by a particular artist, then a new directory is created in that artist's directory with the name of the CD title. In addition, if a particular encoded CD is either a compilation of a particular genre. then a new directory with the name of the CD title is created in the “Compilations” directory. If the CD title is considered to be part of the “Soundtracks” genre, then a new directory with the name of the CD title is created in the “Soundtracks” directory.

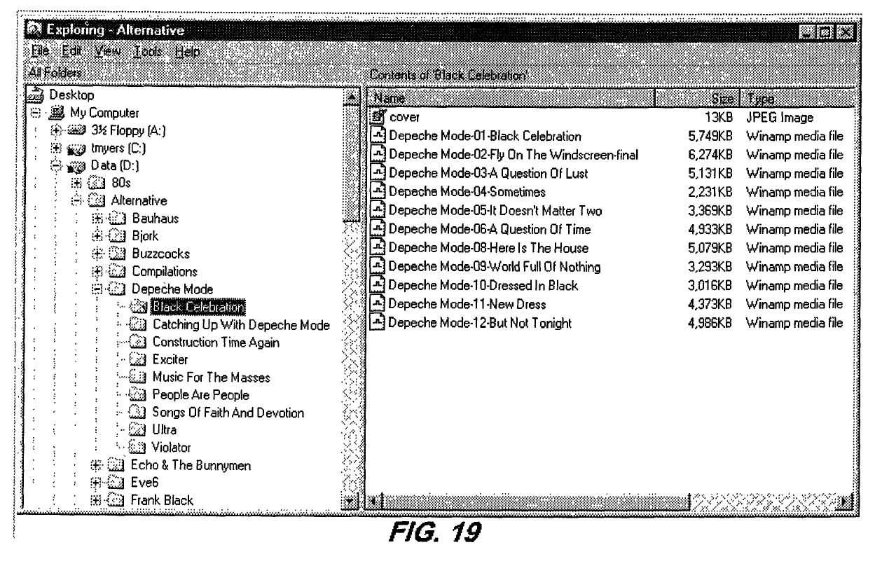

An example of this CD layout and naming convention is shown in FIG. 19.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An interactive graphic user interface for use with a digital jukebox computer system comprising digitally encoded music in a digitally encoded file format, wherein said graphic user interface allows a user to view and manipulate the encoded CDs and select songs from said encoded compact discs to be played or supplied.

2. The interactive graphic user interface according to claim 1, wherein said encoded file format is selected from the group consisting essentially of Motion Picture Experts Group Level 1 Audio Level-3 (MP3 ) and other formats which can be digitally encoded.

3. The interactive graphic user interface according to claim 1, wherein said interface enables non-sequential browsing of the plurality of digitally encoded CDs.

4. The interactive graphic user interface according to claim 1, wherein said interface includes touch screen means for utilizing said interface.

5. The interactive graphic user interface according to claim 1, wherein said touch screen means includes a touch screen keyboard.

6. The interactive graphic user interface according to claim 1, wherein said interface further comprises searching means for searching said compact discs.

7. The interactive graphic user interface according to claim 6, wherein said searching means searches one from the group consisting essentially of song title, author, artist, and CD title.

8. The interactive graphic user interface according to claim 1, wherein said interface includes access means for limiting access to the interface.

9. The interactive graphic user interface according to claim 8, wherein said access means is a password.

10. The interactive graphic user interface according to claim 1, wherein said interface further comprises a money acceptor.

11. The interactive graphic user interface according to claim 10, wherein said money acceptor accepts at least one from the group consisting essentially of money, tokens, credit cards, and passcards.

12. The interactive graphic user interface according to claim 1, wherein said interface further comprises analysis means for analyzing data accumulated regarding said compact discs.

13. The graphic user interface according to claim 12, wherein said analysis means analyzes data selected from the group consisting essentially of number of plays, money accepted, and frequency of plays.

14. An interactive jukebox comprising digitally encoded compact discs in a digitally encoded file and a graphic user interface to playing said compact discs, wherein said graphic user interface allows a user to view and manipulate the encoded CDs and select songs from said encoded CDs to be played or supplied.

15. The interactive jukebox according to claim 14, wherein said encoded file format is selected from the group consisting essentially of Motion Picture Experts Group Level 1 Audio Level-3 (MP3 ) and other formats which can be digitally encoded.

16. The interactive jukebox according to claim 14, wherein said interface enables non-sequential browsing of the plurality of digitally encoded CDs.

17. The interactive jukebox according to claim 14, wherein said interface includes touch screen means for utilizing said interface.

18. The interactive jukebox according to claim 14, wherein said touch screen means includes a touch screen keyboard.

19. The interactive jukebox according to claim 14, wherein said interface further comprises searching means for searching said compact discs.

20. The interactive jukebox according to claim 19, wherein said searching means searches one from the group consisting essentially of song title, author, artist, and CD title.

21. The interactive jukebox according to claim 14, wherein said interface includes access means for limiting access to the interface.

22. The interactive jukebox according to claim 21, wherein said access means is a password.

23. The interactive jukebox according to claim 14, wherein said interface further comprises a money acceptor.

24. The interactive jukebox according to claim 23, wherein said money acceptor accepts at least one from the group consisting essentially of money, tokens, credit cards, and passcards.

25. The interactive jukebox according to claim 14, wherein said interface further comprises analysis means for analyzing data accumulated regarding said compact discs.

26. The jukebox according to claim 25, wherein said analysis means analyzes data selected from the group consisting essentially of number of plays, money accepted, and frequency of plays.

27. An interactive graphic user interface for use with a computer system, comprising:
determining means for determining the identity of at least one of a plurality of encoded audio compact discs stored on the computer system;
accumulating means for accumulating statistical information regarding at least the identity, age, and playback frequency of at least one of the plurality of encoded CDs;
communicating means for communicating with a bill acceptor regarding at least the denomination of any valid currency accepted, detection of a jammed bill, the detection of a full currency stacker, detection of a general failure, and detection of a rejected bill of the bill acceptor;
rendering means for rendering an audio stream suitable for connection to an external amplifier or supplying the name of a file which contains a digitally encoded song and automatically triggering the playing of the song by another player stored on said computer system;
wherein said graphic user interface allows a user to view and manipulate the encoded CDs and select songs from said encoded CDs to be played or supplied to said player.
